(19) United States
(12) Patent Application Publication
(10) Pub. No.: US 2025/0296587 A1
(43) Pub. Date: Sep. 25, 2025

(54) VEHICLE CONTROL DEVICE AND VEHICLE CONTROL METHOD

(71) Applicant: DENSO CORPORATION, Kariya-city (JP)

(72) Inventors: Takuya KUME, Kariya-city (JP); Kazuki IZUMI, Kariya-city (JP)

(21) Appl. No.: 19/233,233

(22) Filed: Jun. 10, 2025

Related U.S. Application Data
(63) Continuation of application No. PCT/JP2023/045313, filed on Dec. 18, 2023.

(30) Foreign Application Priority Data
Jan. 16, 2023 (JP) 2023-004604
Dec. 13, 2023 (JP) 2023-210527

(51) Int. Cl. B60W 50/12; B60W 30/14; B60W 30/18; B60W 30/182; B60W 40/08; B60W 50/02; B60W 50/14; G05D 1/221; G05D 109/10

(52) U.S. Cl. CPC B60W 50/12; B60W 30/146; B60W 30/18163; B60W 30/182; B60W 40/08; B60W 50/0205; B60W 50/14; G05D 1/221; B60W 2040/0827; B60W 2040/0872; B60W 2050/143; B60W 2050/146; B60W 2510/244; B60W 2540/221; B60W 2540/229; B60W 2554/802; G05D 2109/10

(57) ABSTRACT

A vehicle control device for a vehicle with autonomous driving includes: a continuation specifying unit that specifies a continuation amount of the autonomous driving, which is a continuous driving time or a continuous driving distance of the vehicle in the autonomous driving; and a drive restriction unit that executes a driving restriction, which is a restriction on the autonomous driving, when the continuation amount of the autonomous driving specified by the continuation specifying unit exceeds a predetermined threshold.

### CROSS REFERENCE TO RELATED APPLICATION

The present application is a continuation application of International Patent Application No. PCT/JP2023/045313 filed on Dec. 18, 2023, which designated the U.S. and claims the benefit of priority from Japanese Patent Applications No. 2023-004604 filed on Jan. 16, 2023 and No. 2023-210527 filed on Dec. 13, 2023. The entire disclosures of all of the above applications are incorporated herein by reference.

### TECHNICAL FIELD

The present disclosure relates to a vehicle control device and a vehicle control method.

### BACKGROUND

A conceivable technique teaches an autonomous driving control unit that includes autonomous driving functions from level 1 to level 5 in addition to the manual driving function at level 0. A private car and a passenger transport vehicle and the like are known as an examples of autonomous driving vehicles. In the autonomous driving operation, the driver's driving operations are reduced or eliminated, thereby reducing the driver's fatigue caused by the driving operations.

### SUMMARY

According to an example, a vehicle control device for a vehicle with autonomous driving may include: a continuation specifying unit that specifies a continuation amount of the autonomous driving, which is a continuous driving time or a continuous driving distance of the vehicle in the autonomous driving; and a drive restriction unit that executes a driving restriction, which is a restriction on the autonomous driving, when the continuation amount of the autonomous driving specified by the continuation specifying unit exceeds a predetermined threshold.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a diagram showing an example of a schematic configuration of a vehicle system according to a first embodiment;

FIG. 2 is a diagram showing an example of a schematic configuration of an autonomous driving ECU according to the first embodiment;

FIG. 3 is a flowchart showing an example of the flow of a continuation response related process in the autonomous driving ECU according to the first embodiment;

FIG. 4 is a diagram showing an example of a schematic configuration of a vehicle system according to a second embodiment;

FIG. 5 is a diagram showing an example of a schematic configuration of an autonomous driving ECU according to the second embodiment;

FIG. 6 is a flowchart showing an example of the flow of a continuation response related process during remote autonomous driving in the autonomous driving ECU according to the second embodiment;

FIG. 7 is a diagram showing an example of a schematic configuration of a vehicle system according to a third embodiment;

FIG. 8 is a diagram showing an example of a schematic configuration of an autonomous driving ECU according to the third embodiment;

FIG. 9 is a flowchart showing an example of the flow of a continuation response related process in the autonomous driving ECU according to the third embodiment;

FIG. 10 is a diagram showing an example of a schematic configuration of a vehicle system according to a fourth embodiment;

FIG. 11 is a diagram showing an example of a schematic configuration of an autonomous driving ECU according to the fourth embodiment;

FIG. 12 is a diagram showing an example of a schematic configuration of a vehicle system according to a fifth embodiment;

FIG. 13 is a diagram showing an example of a schematic configuration of an autonomous driving ECU according to the fifth embodiment;

FIG. 14 is a diagram showing an example of a schematic configuration of a vehicle system according to a sixth embodiment;

FIG. 15 is a diagram showing an example of a schematic configuration of an autonomous driving ECU according to the sixth embodiment;

FIG. 16 is a diagram showing an example of a schematic configuration of a vehicle system according to a seventh embodiment;

FIG. 17 is a diagram showing an example of a schematic configuration of an autonomous driving ECU according to the seventh embodiment;

FIG. 18 is a diagram showing an example of a schematic configuration of a vehicle system according to an eighth embodiment;

FIG. 19 is a diagram showing an example of a schematic configuration of an autonomous driving ECU according to the eighth embodiment;

FIG. 20 is a diagram showing an example of a schematic configuration of a vehicle system according to an ninth embodiment;

FIG. 21 is a diagram showing an example of a schematic configuration of an autonomous driving ECU according to the ninth embodiment;

FIG. 22 is a diagram showing an example of a schematic configuration of a vehicle system according to a tenth embodiment; and

FIG. 23 is a diagram showing an example of a schematic configuration of an autonomous driving ECU according to the tenth embodiment.

### DETAILED DESCRIPTION

In the autonomous driving mode, the driver is less fatigued by the driving operations, so that the vehicle is more likely to be driven for longer periods of time or longer distances than in the manual driving mode. However, when the vehicle is driven autonomously for a long time or long distance, the load on the vehicle system side may become greater than when the vehicle is driven manually. For example, there is an increase in the load on the brakes due to frequent braking when traveling downhill at a set vehicle speed. Other difficulties include the increase in the load on the driving power source and tires due to frequent acceleration and deceleration required to travel at a set vehicle speed. In addition, when a vehicle is driven for a long time or long distance in an autonomous driving mode, the load on the occupant other than fatigue may be greater than in a manual driving mode. For example, if the driver is away from the driving operation for a long period of time, it may become difficult for the driver to quickly switch to the manual driving. In addition, the occupant may be concerned about the influence of the autonomous driving for a long time or long distance on the vehicle system.

One object of the present embodiments is to provide a vehicle control device and a vehicle control method that make it possible to reduce the load on the vehicle system or occupants caused by continuing the autonomous driving for a long time or long distance.

The above object is achieved by the combination of features described in the embodiments, and the embodiments define further advantageous specific examples of the disclosure. Here, a reference numeral in parentheses in the embodiments indicate a correspondence relationship with specific means described in embodiments to be described later as one aspect, and does not limit the technical scope of the present embodiments.

In order to achieve the above-described features, a vehicle control device according to a first aspect of the present embodiments is a vehicle control device that can be used in a vehicle that executes autonomous driving. The vehicle control device includes: a continuation specifying unit that specifies a continuation amount of the autonomous driving, which is a continuous driving time or a continuous driving distance of the vehicle in the autonomous driving; and a drive restriction unit that executes a driving restriction, which is a restriction on the autonomous driving, when the continuation amount of the autonomous driving specified by the continuation specifying unit exceeds a predetermined threshold.

In order to achieve the above-described features, a vehicle control method according to a first aspect of the present embodiments is a vehicle control method that can be used in a vehicle that executes autonomous driving.

The vehicle control method includes steps executed by at least one processor and having: a continuation specifying step that specifies a continuation amount of the autonomous driving, which is a continuous driving time or a continuous driving distance of the vehicle in the autonomous driving; and a driving restriction step that executes a driving restriction, which is a restriction on the autonomous driving, when the continuation amount of the autonomous driving specified by the continuation specifying step exceeds a predetermined threshold.

By restricting the autonomous driving, it is possible to reduce the load on the vehicle or its occupant. Therefore, with the above configuration, it is possible to reduce the load on the vehicle or the occupant caused by longer continuous driving time or longer continuous driving distance in the autonomous driving. As a result, it becomes possible to reduce the load on the vehicle or the occupant caused by continuing the autonomous driving for a long time or long distance.

In order to achieve the above-described features, a vehicle control device according to a second aspect of the present embodiments is a vehicle control device that can be used in a vehicle that executes autonomous driving. The vehicle control device includes: a continuation specifying unit that specifies a continuation amount of the autonomous driving, which is a continuous driving time or a continuous driving distance of the vehicle in the autonomous driving; and an anomaly specifying unit that specifies a presence or absence of an anomaly in the autonomous driving of the vehicle; and a vehicle compartment notification processing unit that issues a notification to an occupant of the vehicle. When the continuation amount of the autonomous driving specified by the continuation specifying unit exceeds a predetermined threshold and the anomaly specifying unit specifies that there is no anomaly in the autonomous driving, the vehicle compartment notification processing unit issues a notification indicating that there is no difficulty with the vehicle even if the continuation amount of the autonomous driving is large.

In order to achieve the above-described features, a vehicle control method according to a second aspect of the present embodiments is a vehicle control method that can be used in a vehicle that executes autonomous driving. The vehicle control method includes steps executed by at least one processor and having: a continuation specifying step that specifies a continuation amount of the autonomous driving, which is a continuous driving time or a continuous driving distance of the vehicle in the autonomous driving; and an anomaly specifying step that specifies a presence or absence of an anomaly in the autonomous driving of the vehicle; and a vehicle compartment notification processing step that issues a notification to an occupant of the vehicle. When the continuation amount of the autonomous driving specified in the continuation specifying step exceeds a predetermined threshold and it is specified in the anomaly specifying step that there is no anomaly in the autonomous driving, a notification is issued in the vehicle compartment notification processing step such that there is no difficulty with the vehicle even if the continuation amount of the autonomous driving is large.

By issuing the notification indicating that there is no difficulty with the vehicle even if the continuation amount of the autonomous driving, which is the continuous driving time or the continuous driving distance of the vehicle in the autonomous driving, is large in the autonomous driving, it is possible to reassure the occupant. Therefore, according to the above configuration, even if the continuation amount of the autonomous driving is large and when there is no anomaly in the autonomous driving, it is possible to reassure the occupant by issuing the notification. As a result, it becomes possible to reduce the load on the occupant caused by continuing the autonomous driving for a long time or long distance.

The following will describe embodiments of the present disclosure with reference to the drawings. For convenience of explanation, the same reference numerals are assigned to portions having the same functions as those illustrated in the drawings used in the description so far among the plurality of embodiments, and the description of the portions may be omitted. For the elements denoted by the same reference symbols, the description thereof may be referred to in other embodiments.

### FIRST EMBODIMENT

### <Schematic Configuration of Vehicle System 1>

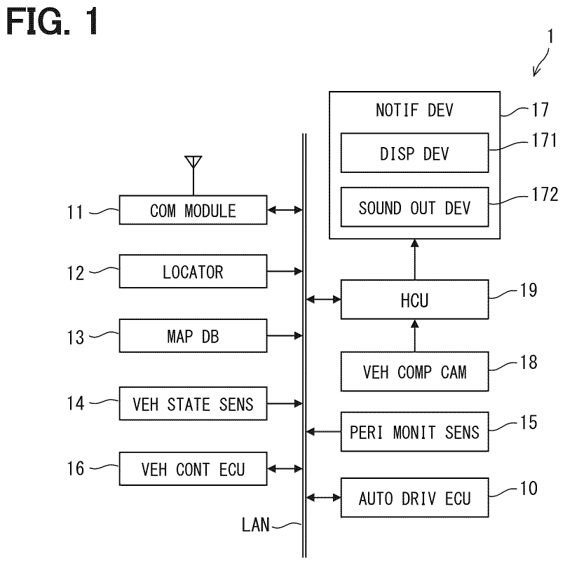

The following will describe a first embodiment of the present disclosure with reference to the accompanying drawings. A vehicle system 1 shown in FIG. 1 can be used for a vehicle configured to perform autonomous driving (hereinafter referred to as an autonomous driving vehicle). The autonomous driving vehicle may be a passenger transport vehicle such as a taxi or a bus, or may be a private car. A private car can also be called a POV (Personally Owned Vehicle).

As shown in FIG. 1, the vehicle system 1 includes an autonomous driving ECU 10, a communication module 11, a locator 12, a map database (hereinafter referred to as map DB) 13, a vehicle state sensor 14, a periphery monitoring sensor 15, a vehicle control ECU 16, a notification device 17, a vehicle compartment camera 18, and a HCU (Human Machine Interface Control Unit) 19. For example, the autonomous driving ECU 10, the communication module 11, the locator 12, the map DB 13, the vehicle state sensor 14, the periphery monitoring sensor 15, the vehicle control ECU 16, and the HCU 19 may be configured to be connected to an in-vehicle LAN (see LAN in FIG. 1). Although the vehicle using the vehicle system 1 is not necessarily limited to an automobile, hereinafter, an example using the automobile will be described.

There may be a plurality of stages (hereinafter, referred to as automation levels) of autonomous driving of an autonomous driving vehicle, for example, as defined by SAE (the Society of Automotive Engineers). This automation level is classified into, for example, five levels including LV 0 to LV 5 as follows.

LV 0 is a level at which a driver performs all driving tasks without intervention of the system. The driving tasks may be rephrased as dynamic driving tasks. The driving tasks are, for example, a steering operation, an acceleration and deceleration operation, and a periphery monitoring operation. The LV 0 corresponds to so-called manual driving. The LV 1 is a level at which the system supports either the steering operation or the acceleration and deceleration operation. The LV 1 corresponds to so-called driving assistance. The LV 2 is a level at which the system supports both the steering operation and the acceleration and deceleration operation. The LV 2 corresponds to so-called partial driving automation. The LV1 and LV2 are also part of autonomous driving.

For example, the autonomous driving at LV 1 and LV 2 is autonomous driving in which a driver has an obligation of monitoring related to safety driving operation (hereinafter simply referred to as a monitoring obligation). That is, this corresponds to autonomous driving with the monitoring obligation. Here, the driving operations at LV0 to LV2 correspond to the driving operations requiring monitoring. The monitoring obligation includes visual monitoring of a periphery of the vehicle. The autonomous driving at LV1 and 2 can be rephrased as autonomous driving in which a second task is not permitted. The second task is an action other than driving permitted for the driver, and is a specific action defined in advance. The second task can also be reworded as a secondary activity, other activities, or the like. The second task must not prevent the driver from responding to a request to take over a driving operation from an autonomous driving system. As an example, viewing of a content such as a video, operation of a smartphone, reading a book, and eating may be assumed as the second task.

The LV 3 of the autonomous driving is a level where the system performs all driving tasks under certain conditions, and the driver performs the driving operation in an emergency situation. In the LV 3 of the autonomous driving, the driver must be able to respond quickly when the system requests to take over the driving operation. The driving takeover can also be rephrased as transfer of the periphery monitoring obligation from the vehicle system to the driver. The LV 3 corresponds to so-called conditional driving automation. The autonomous driving at the LV4 is at a level at which the system can perform all the driving tasks except for a specific situation such as an unsupported road, an extreme environment, and the like. The LV 4 corresponds to so-called advanced driving automation. The LV 5 of the autonomous driving is a level at which the system can perform all the driving tasks under all environments. The LV 5 corresponds to a full driving automation. The autonomous driving of LV4 and LV5 may be implemented, for example, in a traveling section where high-precision map data is prepared. The high-precision map data will be described later.

For example, the autonomous driving at LV 3 or higher is an autonomous driving in which the driver does not have the monitoring obligation. In other words, the autonomous driving at LV 3 to LV 5 corresponds to autonomous driving with no monitoring obligation. The autonomous driving at LV 3 or higher can be rephrased as autonomous driving in which the second task is permitted. For example, the autonomous driving at level 4 or higher is the autonomous driving that allows the driver to sleep. In other words, the autonomous driving at LV 4 or higher corresponds to autonomous driving with sleep permission. The autonomous driving vehicle of this embodiment may, for example, be capable of switching automation levels. The automation levels may be configured to be switchable only between a part of the levels among LV 0 to LV 5. In this embodiment, an example will be described in which an autonomous driving vehicle executes autonomous driving without the obligation to monitor the surroundings.

The communication module 11 transmits and receives information to and from a center outside the vehicle via wireless communications. That is, the communication module 11 executes a wide area communication. The communication module 11 receives traffic congestion information and the like from the center through the wide area communication. The communication module 11 may transmit and receive information to and from other vehicles via the wireless communication. In other words, the communication module 11 may execute a vehicle-to-vehicle communication. The communication module 11 may transmit and receive information via the wireless communication with a roadside device arranged on a roadside. That is, road-to-vehicle communication may be executed. When performing the road-to-vehicle communication, the communication module 11 may receive peripheral vehicle information transmitted from the vehicle positioned in the periphery of the vehicle via the roadside device. Further, the communication module 11 may receive information about a peripheral vehicle transmitted from the vehicle positioned in the periphery of the subject vehicle via the center by the wide area communication.

The locator 12 includes a GNSS (i.e., Global Navigation Satellite System) receiver and an inertial sensor. The GNSS receiver receives positioning signals from a plurality of positioning satellites. The inertial sensor includes, for example, a gyro sensor and an acceleration sensor. The locator 12 combines the positioning signals received by the GNSS receiver with a measurement result of the inertial sensor to sequentially detect the position of the subject vehicle (hereinafter, a subject vehicle position). The subject vehicle position may include, for example, coordinates of latitude and longitude. The subject vehicle position may be measured by using a travel distance acquired from signals sequentially output from a vehicle speed sensor mounted on the vehicle.

The map DB 13 is a non-volatile memory and stores the high-precision map data. The high accuracy map data is map data with higher accuracy than map data used for route guidance by a navigation function. The high-precision map data includes information that can be used for the autonomous driving operation, such as, for example, three-dimensional road shape information, information on the number of lanes, and information indicating the traveling direction allowed for each lane. The high accuracy map data may include information on node points indicating positions of both ends of a road marking such as a lane marking. The map DB 13 may also store map data used for route guidance. The locator 12 may be configured not to use the GNSS receiver by using the three-dimensional shape information on a road. For example, the locator 12 may be configured to specify the vehicle position using three-dimensional shape information of the road and the detection results of the periphery monitoring sensor 15. The three-dimensional shape information of the road may be generated based on a captured image by the REM (i.e., Road Experience Management).

The map data distributed from an external server may be received, for example, through the wide area communications by a communication module 11 and stored in the map DB 13. In this case, the map DB 13 may be a volatile memory, and the communication module 11 may sequentially acquire the map data of an area corresponding to the subject vehicle position.

The vehicle state sensor 14 is a sensor group for detecting various states of the subject vehicle. Examples of the vehicle state sensor 14 may be a vehicle speed sensor, a steering wheel grip sensor, and the like. The vehicle speed sensor detects the speed of the subject vehicle. The steering wheel grip sensor detects whether the driver grips the steering wheel. The vehicle state sensor 14 outputs detected sensing information to the in-vehicle LAN. Here, the sensing information detected by the vehicle state sensor 14 may be output to the in-vehicle LAN via an ECU mounted on the subject vehicle.

The periphery monitoring sensor 15 monitors a peripheral environment of the subject vehicle. For example, the periphery monitoring sensor 15 detects an obstacle in a periphery of the subject vehicle, such as a pedestrian, a mobile object like an other vehicle, and a stationary object such as a fallen object on the road. The road marking such as a traveling lane marking surrounding the subject vehicle is detected. The periphery monitoring sensor 15 is, for example, a periphery monitoring camera that captures an image of a predetermined range around the vehicle, or a probe wave sensor that transmits search waves to a predetermined range around the vehicle. For example, the probe wave sensor may be provided by a sonar, Light Detection and Ranging/Laser Imaging Detection and Ranging (i.e., LIDAR), a millimeter wave radar, or the like. For example, the predetermined range may be a range at least partially including the front area, the rear area, the left area, or the right area of the subject vehicle. The periphery monitoring camera sequentially outputs, as sensing information, sequentially captured images to the autonomous driving ECU 10. The probe wave sensor sequentially outputs the scanning results based on the received signal acquired when receiving a reflection wave reflected by an obstacle to the autonomous driving ECU 10 as sensing information.

The periphery monitoring sensor 15 may include a rain sensor, a temperature sensor, and the like. The rain sensor is a sensor that detects rainfall and snowfall. The temperature sensor is a sensor that detects the outside air temperature. The sensing information detected by the periphery monitoring sensor 15 may be output to the autonomous driving ECU 10 without passing through the in-vehicle LAN.

The vehicle control ECU 16 is an electronic control unit configured to perform a traveling control of the subject vehicle. Examples of the travel control include acceleration and deceleration control and/or steering control. Examples of the vehicle control ECU 16 include a steering ECU that performs steering control, a power unit control ECU that performs the acceleration and deceleration control, and a brake ECU. The vehicle control ECU 16 executes the driving control by outputting control signals to each driving control device mounted on the vehicle. Examples of the driving control devices include an electronic control throttle, a brake actuator, and an EPS (i.e., Electric Power Steering) motor.

The notification device 17 is provided in the vehicle and issues a notification to the vehicle compartment of the vehicle. That is, the notification device 17 issues a notification to the occupants of the vehicle. The notification device 17 executes notification according to an instruction from the HCU 19. The notification device 17 includes a display device 171 and a sound output device 172.

The display device 171 provides the notification by displaying information. The display device 171 may be, for example, a meter MID (i.e., Multi Information Display), a CID (i.e., Center Information Display), or a HUD (i.e., Head-Up Display). The meter MID is a display device located in front of the driver seat in the vehicle compartment. As an example, the meter MID may be arranged on the meter panel. The CID is a display device disposed at a center of an instrument panel of the subject vehicle. The HUD is provided in, for example, the instrument panel in the vehicle compartment. The HUD projects a display image formed by an projector onto a predetermined projection area on a front windshield as a projection member. A light of the display image reflected by the front windshield to an inside of a vehicle compartment is perceived by the driver seated in the driver's seat. As a result, the driver can visually recognize the virtual image of the display image formed in front of the front windshield, which is superimposed on a part of the foreground landscape. The HUD may be configured to project the display image onto a combiner provided in front of the driver's seat instead of the front windshield. The sound output device 172 executes the notification by outputting sound. Examples of the sound output device 172 include a speaker.

The vehicle compartment camera 18 is an imaging device that captures an image of a predetermined range within the compartment of the vehicle. It may be preferable that the vehicle compartment camera 18 captures the image of the range including the driver seat of the subject vehicle at least. The vehicle compartment camera 18 may capture an image in an area including the passenger seat, and the rear seat of the subject vehicle in addition to the driver seat. The vehicle compartment camera 18 includes, for example, a near-infrared light source, a near-infrared camera unit, and a control unit that controls these components. The vehicle compartment camera 18 uses the near-infrared camera to capture an image of the passenger of the subject vehicle to which the near-infrared light is emitted from the near-infrared light source.

The HCU 19 mainly includes a computer including a processor, a volatile memory, a nonvolatile memory, an I/O, and a bus connecting these devices. The HCU 19 executes various processing related to an interaction between a passenger and a system of the subject vehicle by executing a control program stored in the nonvolatile memory. The HCU 19 acquires the images captured by the vehicle compartment camera 18. The HCU 19 specifies the state of the occupants of the vehicle from the images captured by the vehicle compartment camera 18. For example, the HCU 19 specifies whether or not the vehicle occupant is taking a rest based on the posture of the occupant and the degree to which the eyelids are open. The HCU 19 causes the notification device 17 to issue an notification.

The autonomous driving ECU 10 mainly includes a computer including a processor, a volatile memory, a nonvolatile memory, an I/O, and a bus connecting these devices. The autonomous driving ECU 10 executes processing related to the autonomous driving by executing a control program stored in the nonvolatile memory. The autonomous driving ECU 10 corresponds to a vehicle control device. The configuration of the autonomous driving ECU 10 will be described in detail below.

### <Schematic Configuration of Autonomous Driving ECU 10>

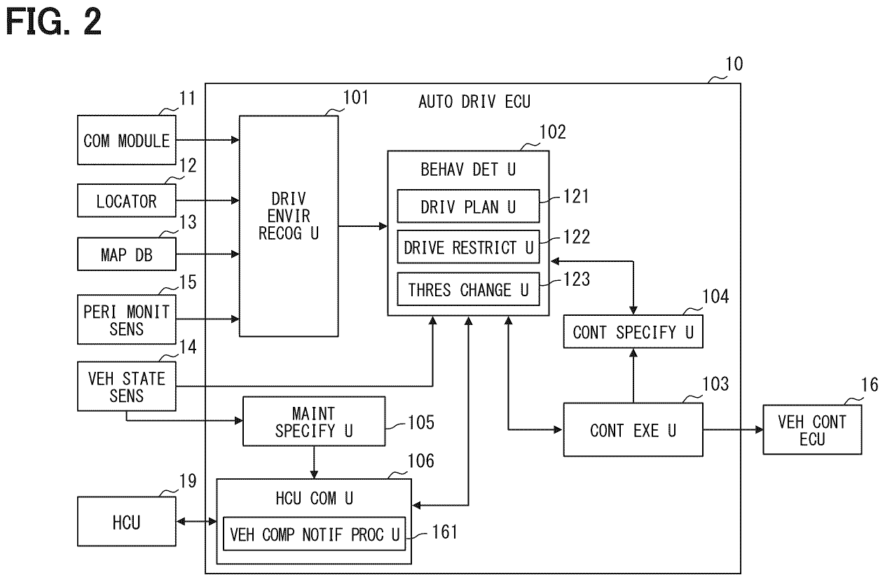

Next, a schematic configuration of the autonomous driving ECU 10 will be described with reference to FIG. 2. As shown in FIG. 2, the autonomous driving ECU 10 has a driving environment recognition unit 101, a behavior determination unit 102, a control execution unit 103, a continuation specifying unit 104, a maintenance specifying unit 105, and an HCU communication unit 106 as functional blocks. The execution of the processes of the functional blocks of the autonomous driving ECU 10 by the computer corresponds to execution of a vehicle control method. Some or all of the functions executed by the autonomous driving ECU 10 may be implemented as hardware with one or more ICs or the like. Some or all of the functional blocks included in the autonomous driving ECU 10 may be implemented by a combination of execution of software by a processor and a hardware element.

The driving environment recognition unit 101 recognizes the driving environment of the vehicle from the vehicle position, map data, and sensing information acquired from the periphery monitoring sensor 15. The vehicle position may be acquired from the locator 12. The map data may be acquired from the map DB 13. As one example, with use of these information, the driving environment recognition unit 101 recognizes a position, a shape and a movement state of an object in the periphery of the subject vehicle, and generates a virtual space in which the actual traveling environment is reproduced. The driving environment recognition unit 101 may recognize, from the sensing information, the presence, relative position, and relative speed of periphery vehicles with respect to the subject vehicle as the driving environment. The driving environment recognition unit 101 may recognize the position of the subject vehicle on the map from the subject vehicle position and the map data. In a case where position information, speed information, and the like of the periphery vehicle can be acquired via the communication module 11, the driving environment recognition unit 101 may recognize the traveling environment using these items of information. The driving environment recognition unit 101 may also recognize the driving environment, such as the outside temperature, weather, and road surface conditions. The outside air temperature can be recognized from the outside air temperature acquired from a temperature sensor. The weather can be recognized from the results detected by a rain sensor. The road surface conditions can be recognized using machine learning from images of the road surface captured by the periphery cameras. In this case, a classifier that is prepared by the machine learning of various road surface conditions, such as sandy roads, may be used. The driving environment recognition unit 101 corresponds to a travel environment specifying unit.

The behavior determination unit 102 switches the control subject of driving operation between the driver and the vehicle system of the subject vehicle. The behavior determination unit 102 determines a traveling plan to travel the subject vehicle based on the recognition result of the travel environment by the driving environment recognition unit 101 when the system has a right to control the driving operation. The behavior determination unit 102 includes a drive plan unit 121, a drive restriction unit 122, and a threshold change unit 123 as sub-functional blocks.

The drive plan unit 121 determines a drive plan for driving the vehicle in the autonomous driving mode. The drive plan unit 121 determines long-term and mid-term driving plans and short-term driving plans as the drive plans. In the long and medium term driving plan, a planned route for causing the subject vehicle to head toward a set destination is generated. The drive plan unit 121 may determine this planned route in a manner similar to the route search of the navigation function. The drive plan unit 121 may also determine the set vehicle speed when driving the planned route. The set vehicle speed may be determined according to the speed limit of each drive section. The set vehicle speed may be, for example, the speed limit for each drive section. The drive plan unit 121 uses the virtual space in the periphery of the subject vehicle generated by the driving environment recognition unit 101 to determine a short-term drive plan for realizing the driving operation according to the long-term and middle-term drive plan. Specifically, the short-term drive plan determines the execution of steering for lane changes, acceleration/deceleration for speed adjustment, and steering and braking for obstacle avoidance. Other processes in the drive plan unit 121, the process in the drive restriction unit 122, and the process in the threshold change unit 123 will be described later.

The control execution unit 103 executes the driving control in cooperation with the vehicle control ECU 16 when the control right of driving operation is held by the system of the vehicle itself. The control execution unit 103 executes the driving control such as acceleration/deceleration control and steering control of the subject vehicle in accordance with the driving plan determined by the behavior determination unit 102.

The continuation specifying unit 104 specifies a continuation amount of the autonomous driving, which is a continuous driving time or a continuous driving distance of the vehicle in the autonomous driving. The autonomous driving continuation amount may be the amount by which the subject vehicle continues to drive autonomously without stopping. The continuation specifying unit 104 may determine the continuation amount of the autonomous driving from the driving time or the driving distance during which the autonomous driving is continued by the control execution unit 103. The process in the continuation specifying unit 104 corresponds to a continuation specifying step.

When determining the drive plan in which the continuation amount of the autonomous driving of the vehicle is scheduled to reach a specific amount, the drive plan unit 121 may preferably execute the following feature. It may be preferable that the drive plan unit 121 determines the drive plan so that the vehicle travels along a route that passes through a point where maintenance of the vehicle can be executed. This makes it easier to execute the maintenance on the vehicle when it becomes necessary. The specific amount may be any value that can be set. The specific amount may be the same as a continuation threshold value described below, or may be a different value. The point where maintenance of the vehicle can be executed include a point such as a service area where vehicles can be changed, a dealership, and the like. An example of the drive plan in which the continuation amount of the autonomous driving is scheduled to reach a specific amount is a long-distance trip on a highway without stopping.

The drive restriction unit 122 restricts the driving in the autonomous driving mode (hereinafter, driving restriction) when the continuation amount of the autonomous driving specified by the continuation specifying unit 104 exceeds a predetermined threshold. The predetermined threshold (hereinafter, the continuation threshold) may be any value that can be set. The continuation threshold may be set to the continuation amount of the autonomous driving that is estimated to put the load on the vehicle or the occupant due to the continuation of the autonomous driving without stopping. The load on the occupant referred to here excludes fatigue. By restricting the autonomous driving, it is possible to reduce the load on the vehicle or its occupant. Therefore, with the above configuration, it is possible to reduce the load on the vehicle or the occupant caused by longer continuous driving time or longer continuous driving distance in the autonomous driving. As a result, it becomes possible to reduce the load on the vehicle or the occupant caused by continuing the autonomous driving for a long time or long distance. The process in the drive restriction unit 122 corresponds to a drive restriction step.

The drive restriction unit 122 may restrict the driving to a low speed. The driving at the low speed here refers to the driving at a speed lower than the set speed for the autonomous driving. According to this, even when the vehicle cannot be stopped, the load on the vehicle or the occupant can be reduced by reducing the speed of the vehicle. As a result, it becomes possible to reduce the load on the vehicle or the occupant caused by continuing the autonomous driving for a long time or long distance.

The drive restriction by the drive restriction unit 122 may be a temporary stop. In other words, the driving operation may be interrupted. According to this, since the vehicle is stopped, it is possible to reduce the load on the vehicle or the occupant to a greater extent. As a result, it becomes possible to reduce the load on the vehicle or the occupant caused by continuing the autonomous driving for a long time or long distance.

The driving restriction by the drive restriction unit 122 may be a prohibition of the autonomous driving. In other words, the driving may be switched to manual driving. According to this, the autonomous driving of the subject vehicle is terminated, so that it is possible to reduce the load on the vehicle or the occupant caused by the autonomous driving. As a result, it becomes possible to reduce the load on the vehicle or the occupant caused by continuing the autonomous driving for a long time or long distance.

The drive restriction by the drive restriction unit 122 may alternate between a full mode in which the vehicle is driven at a set vehicle speed for the autonomous driving and a recovery mode in which the vehicle is driven at a speed lower than the set vehicle speed for the autonomous driving. For example, the full mode may be set to 100 km/h, and the recovery mode may be set to 60 km/h. The repetition period may be set arbitrarily. According to this, it is possible to reduce the load on the vehicle or the occupant by the amount of the speed of the vehicle being periodically reduced. As a result, it becomes possible to reduce the load on the vehicle or the occupant caused by continuing the autonomous driving for a long time or long distance.

When the drive restriction unit 122 executes the drive restriction, the drive restriction unit 122 may be configured to select and execute the drive restriction according to the situation of the vehicle. The situation of the vehicle may be specified from the recognition result of the drive environment recognition unit 101. For example, if the vehicle is in a situation where the vehicle cannot be stopped, the vehicle may select to drive at a low speed. If the vehicle is in a situation where the vehicle can be stopped, the vehicle may be stopped temporarily. In situations where it is easy to take over the driving operation, the prohibition of the autonomous driving may be selected. An example of a situation in which it is easy to take over the driving operation is a case where the vehicle is driving on a highway. The highway may include a motor highway for automobiles only. According to the above configuration, it is possible to execute a more effective type of the drive restriction that can be implemented in the situation in which the subject vehicle is placed.

When the continuation amount of the autonomous driving specified by the continuation specifying unit 104 exceeds the continuation threshold, it may be preferable that the drive restriction unit 122 executes the drive restriction at a timing when the vehicle's behavior is low. If the drive restriction is executed at a time when the vehicle's behavior becomes high, the vehicle's behavior may be likely to become unstable, and the comfort of the vehicle occupants may be likely to be impaired. In contrast, with the above configuration, the behavior of the vehicle is less likely to be disturbed by the drive restriction, and the comfort of the occupants is less likely to be impaired. An example of a timing when the vehicle behavior is low is when the vehicle is traveling other than at an intersection. Whether or not the vehicle is passing through an intersection can be determined from the recognition result by the drive environment recognition unit 101. An example of a timing when the vehicle behavior is low is when the vehicle is traveling on a straight road. Whether or not the vehicle is passing along a straight road can be determined from the recognition result by the drive environment recognition unit 101. An example of a timing when the vehicle behavior is low is when the vehicle arrives at the next scheduled stopping point. Arrival at the next scheduled stop point may be determined from the drive plan determined by the drive plan unit 121 and the vehicle's position.

It may be preferable that the threshold change unit 123 changes the continuation threshold to a smaller value as the driving environment specified by the driving environment recognition unit 101 becomes a worse condition for driving the subject vehicle. According to this, the worse the conditions for driving the subject vehicle, the earlier the drive restriction can be executed. It may be considered that the worse the conditions for driving the vehicle, the greater the load on the vehicle due to the continuation of the autonomous driving. In response to this, the above configuration makes it possible to execute the driving restriction in accordance with the driving environment of the vehicle so as to prevent the load on the vehicle from becoming too large. An example of the bad condition for driving the vehicle includes an environment where the temperature is too high or too low. An example of the bad condition for driving the vehicle includes an environment where the weather is rainy or snowy. An example of the bad condition for driving the vehicle includes an environment in which the road is sandy. The degree of the bad condition for driving the vehicle may be expressed in two stages, i.e., a degree of not the bad condition for driving the vehicle and a degree of the bad condition for driving the vehicle, or may be expressed in three or more stages.

The maintenance specifying unit 105 specifies whether or not maintenance of the vehicle is required. The maintenance specifying unit 105 may specify, from the sensing information of the vehicle state sensor 14, whether or not maintenance of the vehicle is required. For example, if the value detected by the vehicle state sensor 14 is outside the normal range, it may be determined that maintenance of the vehicle is required.

The HCU communication unit 106 executes an output process of the information to the HCU 18 and an acquisition process of the information from the HCU 18. The HCU communication unit 106 acquires information on images captured by the vehicle compartment camera 18, and the like. The HCU communication unit 106 has an vehicle compartment notification processing unit 161 as a sub-functional block. The vehicle compartment notification processing unit 161 indirectly controls the notification by the notification device 17 by transmitting an instruction to the HCU 18. That is, the vehicle compartment notification processing unit 161 issues a notification to the occupants of the vehicle.

The vehicle compartment notification processing unit 161 sequentially calculates the difference between the autonomous driving continuation amount specified by the continuation specifying unit 104 and the continuation threshold value. This difference is referred to below as the margin value. The margin value may be calculated by the behavior determination unit 102. It may be preferable that the vehicle compartment notification processing unit 161 causes the notification device 17 to issue a rest suggestion notification and a drive restriction notification when the margin value falls below a predetermined value. The predetermined value may be set to a value small enough that the continuation amount of the autonomous driving specified by the continuation specifying unit 104 is likely to exceed the continuation threshold value. The predetermined value may be arbitrarily set. The rest suggestion notification made by the notification device 17 is a notification suggesting a rest to the occupants of the vehicle. This rest suggestion notification may be made by display on the display device 171 or by audio output from the sound output device 172. The drive restriction notification issued by the notification device 17 is a notification regarding the drive restriction that will be executed if the occupant does not take a rest. The drive restriction notification may include, for example, notification of the details of the drive restriction. This drive restriction notification may be made by display on the display device 171 or by audio output from the sound output device 172. According to the above configuration, it is possible to reduce the load on the occupant other than fatigue without executing the drive restriction. In addition, the occupant will be able to select whether to reduce the load other than fatigue on the occupant's side by taking a rest or by executing the drive restriction. Therefore, it is possible to reduce the load on the occupants other than fatigue, caused by the continuation of the autonomous driving by means of measures that are more comfortable for the occupant.

It may be preferable that the vehicle compartment notification processing unit 161 issues a check prompt notification when the margin value falls below a set value. This set value may be the same as the predetermined value described above, or may be a different value. In the following, an example will be described in which this set value is the same as the predetermined value described above. The check prompt notification is a notification that prompts the occupants of the vehicle to check the vehicle. This check prompt notification may be made by display on the display device 171 or by audio output from the sound output device 172. The check prompt notification may, for example, display a part of the vehicle that is recommended to be checked. According to the above configuration, even if an anomaly for which the need for maintenance cannot be specified from the sensing information of the vehicle state sensor 14, it can be confirmed by the check by the occupant. This will make it easier to remove passenger concerns about continuing the autonomous driving.

It may be preferable that the vehicle compartment notification processing unit 161 causes the notification device 17 to periodically issue a notification as to whether or not the maintenance is required based on the specification result of the maintenance specifying unit 105 while the vehicle is in the autonomous driving mode. The notification of the maintenance requirement is a notification that notifies the user whether or not maintenance is needed for the vehicle. According to the above configuration, by the occupant receiving the notification of the maintenance requirement, it becomes easier to remove the occupant's anxiety about the continuation of the autonomous driving. The vehicle compartment notification processing unit 161 may determine the period for issuing a notification of the maintenance requirement using a timer circuit or the like. This period may be set arbitrarily. As an example, the starting point for periodically issuing a notification of the maintenance requirement may be the start of the autonomous driving. In addition, the vehicle compartment notification processing unit 161 may be configured to periodically issue a notification of the maintenance requirement from the notification device 17 when the continuation amount of the autonomous driving specified by the continuation specifying unit 104 exceeds a continuation threshold. According to this, during periods when the possibility of maintenance being required is low, the notification of the maintenance requirement, which is less necessary, can be suppressed, thereby reducing annoyance. In this case, the periodic notification of the maintenance requirement starts from the time point when the continuation amount of the autonomous driving exceeds the continuation threshold.

### <Continuation Response Related Process in the Autonomous Driving ECU 10>

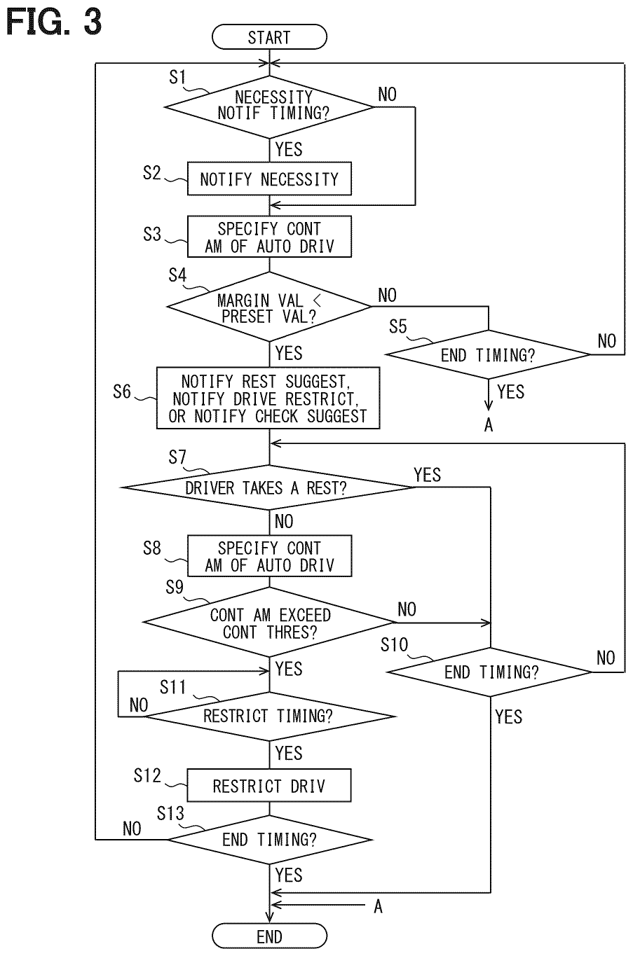

Here, an example of the flow of process related to a response when the autonomous driving is continued in the autonomous driving ECU 10 (hereinafter, continuation response-related process) will be described with reference to the flowchart of FIG. 3. The flowchart in FIG. 3 may be configured to start when the subject vehicle starts driving by the autonomous driving.

First, in step S1, the vehicle compartment notification processing unit 161 determines whether or not it is time to issue the periodic notification of the maintenance requirement. If it is time to issue the periodic notification of the maintenance requirement (i.e., “YES” in S1), the process proceeds to step S2. On the other hand, if it is not the timing to issue the periodic notification of the maintenance requirement (i.e., “NO” in S1), the process proceeds to step S3.

In step S2, the vehicle compartment notification processing unit 161 issue the periodic notification of the maintenance requirement. In step S3, the continuation specifying unit 104 specifies the autonomous driving continuation amount. The process of S3 may be executed before the process of S1.

In step S4, the vehicle compartment notification processing unit 161 calculates a margin value, which is the difference between the autonomous driving continuation amount specified in S3 and a continuation threshold value. If the margin value is less than the continuation threshold value (“YES” in S4), the process proceeds to step S6. On the other hand, if the margin value is equal to or greater than the continuation threshold value (“NO” in S4), the process proceeds to step S5.

In step S5, if it is time to end the continuation response related process (“YES” in S5), the continuation response related process is ended. On the other hand, when it is not the end timing of the continuation response related process (“NO” in S5), the process returns to S1 and repeats the process. Examples of timings for ending the continuation response related process include ending of the autonomous driving, stopping of the subject vehicle, and the like.

In step S6, the vehicle compartment notification processing unit 161 causes the notification device 17 to issue a rest suggestion notification, a drive restriction notification, and a check prompt notification. In addition, in S6, only one of the rest suggestion notification and the drive restriction notification and the check prompt notification may be executed.

In step S7, it is determined whether or not the occupant has taken a rest. The determination as to whether the occupant has taken a rest may be made by the behavior determination unit 102 or by the HCU communication unit 106. For example, it may be possible to determine whether or not the occupant of the vehicle has taken a rest based on whether or not the occupant has taken a rest as determined by the HCU 19. Alternatively, whether or not the occupant has taken a rest may be determined based on whether or not the vehicle is stopped. If it is determined that the occupant has taken a rest (“YES” in S7), the process proceeds to step S10. On the other hand, if it is determined that the occupant has not taken a rest (“NO” in S7), the process proceeds to step S8.

In step S8, the continuation specifying unit 104 specifies the autonomous driving continuation amount. In step S9, the drive restriction unit 122 determines whether or not the autonomous driving continuation amount specified in S8 exceeds a continuation threshold value. Then, when the continuation amount of the autonomous driving exceeds the continuation threshold value (“YES” in S9), the process proceeds to step S10. On the other hand, if the continuation amount of the autonomous driving does not exceed the continuation threshold value (“NO” in S9), the process proceeds to step S10.

In step S10, if it is time to end the continuation response related process (“YES” in S10), the continuation response related process is ended. On the other hand, when it is not the end timing of the continuation response related process (“NO” in S10), the process returns to S8 and repeats the process.

In step S11, the drive restriction unit 122 determines whether or not it is a timing when the vehicle behavior is low (hereinafter, referred to as the restriction timing). If it is the restriction timing (“YES” in S11), the process proceeds to step S12. On the other hand, if it is not the restriction timing (“NO” in S11), the process of S11 is repeated. In step S12, the drive restriction unit 122 executes the drive restriction. The drive restriction here is to drive the vehicle at a low speed or to stop the vehicle.

In step S13, if it is time to end the continuation response related process (“YES” in S13), the continuation response related process is ended. On the other hand, when it is not the end timing of the continuation response related process (“NO” in S13), the process returns to S1 and repeats the process.

### SECOND EMBODIMENT

The present disclosure is not limited to the configuration described in the above embodiment, but can also adopt the following configuration as a second embodiment. The following will describe an example of a configuration of the second embodiment with reference to the drawings.

<Schematic Configuration of Vehicle System 1a>

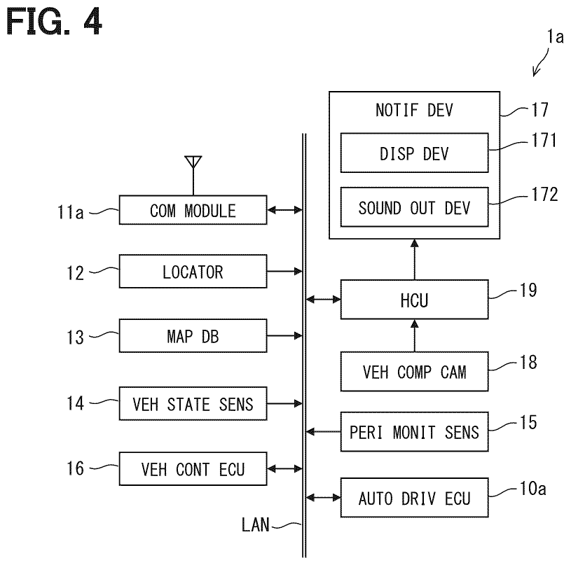

A vehicle system 1a illustrated in FIG. 4 can be used in a vehicle (hereinafter, the remote operation vehicle) capable of executing the autonomous driving by the remote operation. The remote operation vehicle may execute the vehicle control in accordance with a remote operation command value transmitted from the monitoring center to achieve the autonomous driving by a remote operation. The autonomous driving executed by the remote control is referred to as remote autonomous driving below. In the remote autonomous driving, for example, the autonomous driving at an automation level of LV2 or higher may be executed. In the following, the remote autonomous driving will be described as executing the autonomous driving at an automation level of LV2 or LV3.

As shown in FIG. 4, the vehicle system 1a includes an autonomous driving ECU 10a, a communication module 11a, a locator 12, a map DB 13, a vehicle state sensor 14, a periphery monitoring sensor 15, a vehicle control ECU 16, a notification device 17, a vehicle compartment camera 18, and an HCU 19. The vehicle system 1a includes an autonomous driving ECU 10a instead of the autonomous driving ECU 10. The vehicle system 1a includes the communication module 11a instead of the communication module 11. The vehicle system 1a is similar to the vehicle system 1 of the first embodiment except for these points.

The communication module 11a is similar to the communication module 11 of the first embodiment except that some processes are different. This different point will be described below. In a case where the remote operation command value is transmitted from the monitoring center, the communication module 11a receives the remote operation command value. The monitoring center is a center for executing a remote operation of the autonomous driving vehicle. The monitoring center transmits a remote operation command value corresponding to a driving operation input to the operation system by the remote operator. A remote operator remotely operates the remote operation vehicle from outside the vehicle. The communication module 11a may receive the remote operation command values from a monitoring center via wide area communication.

<Schematic Configuration of Autonomous Driving ECU 10a>

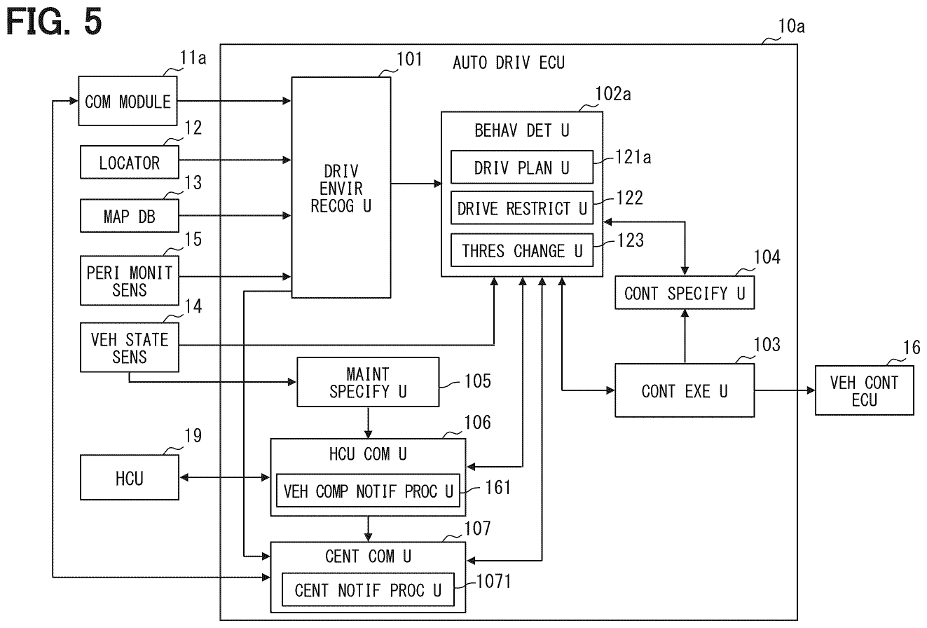

Next, a schematic configuration of the autonomous driving ECU 10a will be described with reference to FIG. 5. The autonomous driving ECU 10a is similar to the autonomous driving ECU 10 of the first embodiment, except for some differences in processing. The autonomous driving ECU 10a has a driving environment recognition unit 101, a behavior determination unit 102a, a control execution unit 103, a continuation specifying unit 104, a maintenance specifying unit 105, an HCU communication unit 106, and a center communication unit 107 as functional blocks. The autonomous driving ECU 10a includes a behavior determination unit 102a instead of the behavior determination unit 102. The autonomous driving ECU 10a is equipped with a center communication unit 107. Except for these points, the autonomous driving ECU 10a is similar to the autonomous driving ECU 10 of the first embodiment. The automated driving ECU 10a also corresponds to the vehicle control device. The execution of the processes of the functional blocks of the autonomous driving ECU 10a by the computer corresponds to execution of a vehicle control method.

The behavior determination unit 102a is similar to the behavior determination unit 102 of the first embodiment, except for some differences in processing. The behavior determination unit 102a includes a drive plan unit 121a, a drive restriction unit 122, and a threshold change unit 123 as sub-functional blocks. The behavior determination unit 102a is similar to the behavior determination unit 102 of the first embodiment, except that the behavior determination unit 102a includes a drive plan unit 121a instead of the drive plan unit 121.

The drive plan unit 121a is similar to the drive plan unit 121 of the first embodiment, except for some differences in processing. This different point will be described below. The drive plan unit 121a determines a drive plan in accordance with the remote operation command values received from the monitoring center. As a result, the remote operation vehicle executes the autonomous driving according to the remote operation command value. The drive plan unit 121a may acquire the remote operation command values via the communication module 11a. In addition, the behavior determination unit 102a determines whether or not to continue the remote automated driving. The behavior determination unit 102a may determine that the autonomous driving cannot be continued, for example, in a case where the communication situation with the monitoring center deteriorates. When the behavior determination unit 102a determines that the autonomous driving cannot be continued, the autonomous driving ECU 10a switches the driving operation to those of the occupant of the remote control vehicle.

The center communication unit 107 executes the output process for outputting information to the monitoring center and the acquisition process for acquiring information from the monitoring center via the communication module 11a. The center communication unit 107 acquires remote operation command values transmitted from the monitoring center. The center communication unit 107 includes a center notification processing unit 1071 as a sub-functional block. The center notification processing unit 1071 indirectly controls notifications from the notification device of the monitoring center by transmitting instructions to the monitoring center. That is, the center notification processing unit 1071 issues a notification to a remote operator at the monitoring center.

When the vehicle is in remote autonomous driving mode and the margin value falls below a predetermined value, the center notification processing unit 1071 causes a rest suggestion notification and a drive restriction notification to be issued from the monitoring center. The margin value is the difference between the autonomous driving continuation amount specified by the continuation specifying unit 104 and the continuation threshold value. The margin value may be calculated by the center notification processing unit 1071 or by the behavior determination unit 102. The continuation threshold and the predetermined value may be the same as those described in the first embodiment. The rest suggestion notification issued by the monitoring center is a notification to the remote operator suggesting that the remote operator takes a break. This rest suggestion notification may be made by display or by audio output. The drive restriction notification issued by the monitoring center is a notification regarding the drive restriction that will be executed if the remote operator does not take a rest. The drive restriction notification may include, for example, notification of the details of the drive restriction. The drive restriction notification may be executed by display or by audio output. According to the above configuration, it is possible to reduce the load on the remote operator without executing the drive restriction. In addition, the remote operator can select whether to reduce the load on the remote operator by taking a rest for the remote operator or by executing the drive restriction. Therefore, it is possible to reduce the load on the remote operator caused by continuing the autonomous driving by comfortable means for the remote operator.

When the vehicle is in the remote autonomous driving mode and the margin value falls below a predetermined value, the center notification processing unit 1071 may issue a changeover suggestion notification to a remote operator at the monitoring center. The changeover suggestion notification is a notification that suggests a changeover of remote control. According to the above configuration, the load on the remote operator can be reduced by switching between remote operators.

<Continuation Response Related Process in the Autonomous Driving ECU 10a>

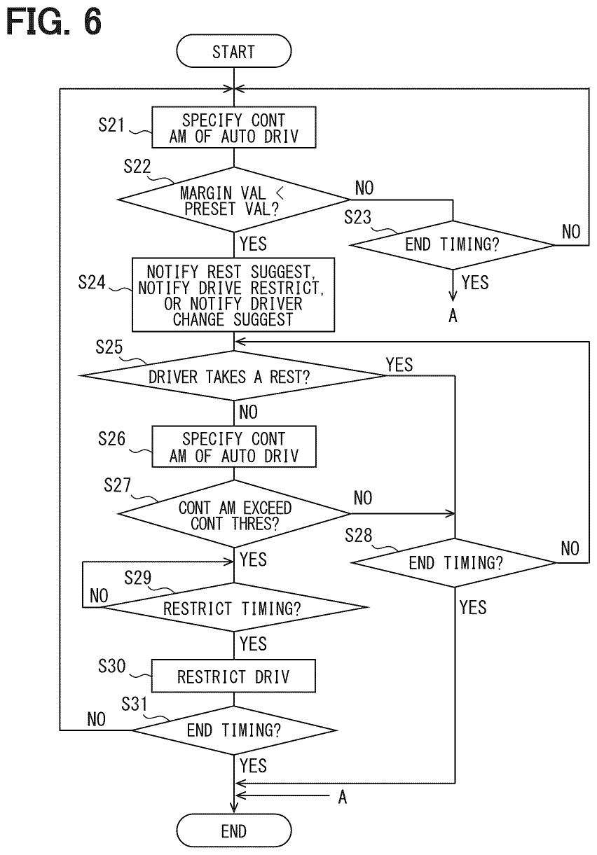

Here, an example of the flow of the continuation response related process during the remote autonomous driving in the autonomous driving ECU 10a will be described with reference to the flowchart of FIG. 6. The flowchart in FIG. 6 may be configured to start when the subject vehicle starts driving by the remote autonomous driving.

In step S21, the continuation specifying unit 104 specifies the autonomous driving continuation amount. In step S22, the center notification processing unit 1071 calculates a margin value, which is the difference between the autonomous driving continuation amount specified in S1 and a continuation threshold value. If the margin value is less than the predetermined value (“YES” in S22), the process proceeds to step S24. On the other hand, if the margin value is equal to or greater than the predetermined value (“NO” in S22), the process proceeds to step S23.

In step S23, if it is time to end the continuation response related process (“YES” in S23), the continuation response related process is ended. On the other hand, when it is not the end timing of the continuation response related process (“NO” in S23), the process returns to S1 and repeats the process. Examples of timings for ending the continuation response related process include ending of the remote autonomous driving, stopping of the subject vehicle, and the like.

In step S24, the center notification processing unit 1071 causes the monitoring center to issue a rest suggestion notification, a drive restriction notification, and a changeover suggestion notification. In addition, in S24, only one of the rest suggestion notification and the drive restriction notification and the changeover suggestion notification may be executed.

In step S25, it is determined whether the remote operator at the monitoring center has taken a rest. The behavior determination unit 102a or the center communication unit 107 may determine whether the remote operator has taken a rest. For example, whether or not the remote operator has taken a rest may be determined from information capable of specifying whether or not the remote operator has taken a rest, which is acquired from the monitoring center via the communication module 11a. Alternatively, whether or not the remote operator has taken a rest may be determined based on whether or not the vehicle has stopped. When a remote operator is changed, it may be regarded as if the remote operator has taken a rest. If it is determined that the remote operator has taken a rest (“YES” in S25), the process proceeds to step S28. On the other hand, if it is determined that the remote operator has not taken a rest (“NO” in S25), the process proceeds to step S26.

In step S26, the continuation specifying unit 104 specifies the autonomous driving continuation amount. In step S27, the drive restriction unit 122 determines whether or not the autonomous driving continuation amount specified in S26 exceeds a continuation threshold value. Then, when the continuation amount of the autonomous driving exceeds the continuation threshold value (“YES” in S27), the process proceeds to step S29. On the other hand, if the continuation amount of the autonomous driving does not exceed the continuation threshold value (“NO” in S27), the process proceeds to step S28.

In step S28, if it is time to end the continuation response related process (“YES” in S28), the continuation response related process is ended. On the other hand, when it is not the end timing of the continuation response related process (“NO” in S28), the process returns to S25 and repeats the process.

In step S29, the drive restriction unit 122 determines whether or not it is a timing when the vehicle behavior is low (hereinafter, referred to as the restriction timing). If it is the restriction timing (“YES” in S29), the process proceeds to step S30. On the other hand, if it is not the restriction timing (“NO” in S29), the process of S29 is repeated. In step S30, the drive restriction unit 122 executes the drive restriction.

In step S31, if it is time to end the continuation response related process (“YES” in S31), the continuation response related process is ended. On the other hand, when it is not the end timing of the continuation response related process (“NO” in S31), the process returns to S21 and repeats the process.

In addition, in the case where the vehicle is capable of switching between the remote autonomous driving and the autonomous driving not based on the remote control, the configuration may be a combination of first embodiment and the second embodiment. In this case, when the vehicle is being remotely controlled, the configuration of the second embodiment may be applied. When the vehicle is autonomously driving without being remotely controlled, the configuration of the first embodiment may be applied.

### THIRD EMBODIMENT

The present disclosure is not limited to the configuration described in the above embodiment, but can also adopt the following configuration as a third embodiment. The following feature will be described as an example of a configuration of the third embodiment with reference to the accompanying drawings.

<Schematic Configuration of Vehicle System 1b>

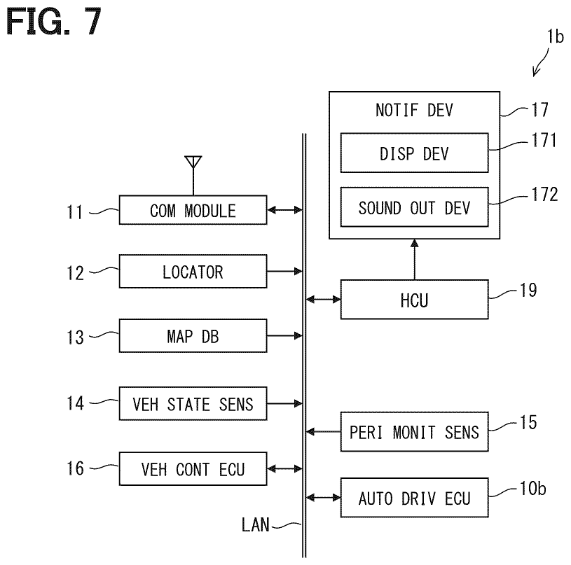

A vehicle system 1b shown in FIG. 7 can be used in an autonomous driving vehicle. As shown in FIG. 7, the vehicle system 1b includes an autonomous driving ECU 10b, a communication module 11, a locator 12, a map DB 13, a vehicle state sensor 14, a periphery monitoring sensor 15, a vehicle control ECU 16, a notification device 17, and an HCU 19. The vehicle system 1b includes an autonomous driving ECU 10b instead of the autonomous driving ECU 10. The vehicle system 1b does not include a vehicle compartment camera 18. The vehicle system 1b is similar to the vehicle system 1 of the first embodiment except for these points.

<Schematic Configuration of Autonomous Driving ECU 10b>

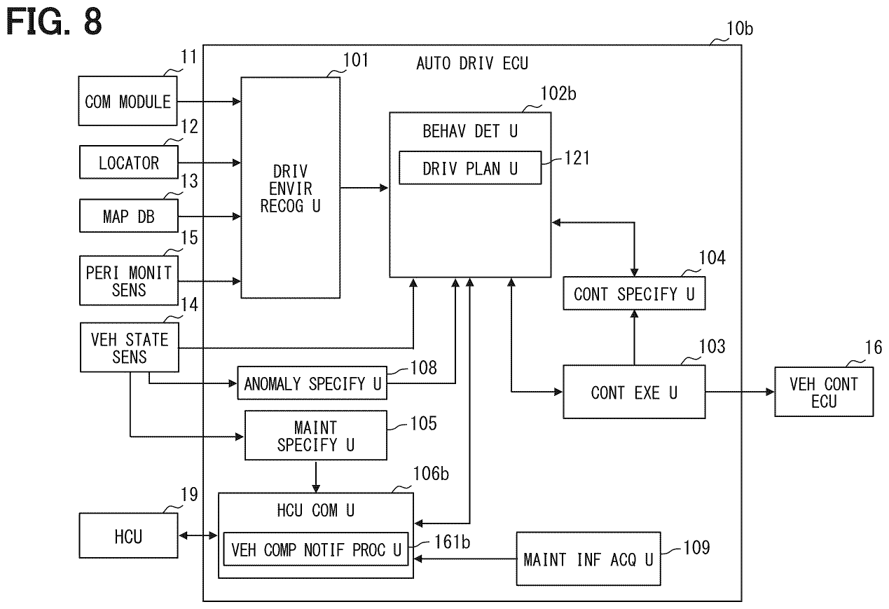

Next, a schematic configuration of the autonomous driving ECU 10b will be described with reference to FIG. 8. The autonomous driving ECU 10b is similar to the autonomous driving ECU 10 of the first embodiment, except for some differences in processing. The autonomous driving ECU 10b has a driving environment recognition unit 101, a behavior determination unit 102b, a control execution unit 103, a continuation specifying unit 104, a maintenance specifying unit 105, an HCU communication unit 106b, an anomaly specifying unit 108, and a maintenance information acquisition unit 109 as functional blocks. The autonomous driving ECU 10b includes a behavior determination unit 102b instead of the behavior determination unit 102. The autonomous driving ECU 10b is equipped with an HCU communication unit 106b instead of the HCU communication unit 106. The autonomous driving ECU 10b is equipped with an anomaly specifying unit 108 and a maintenance information acquisition unit 109. Except for these points, the autonomous driving ECU 10b is similar to the autonomous driving ECU 10 of the first embodiment. The autonomous driving ECU 10b also corresponds to the vehicle control device. The execution of the processes of the functional blocks of the autonomous driving ECU 10b by the computer corresponds to execution of a vehicle control method.

The behavior determination unit 102b is similar to the behavior determination unit 102 of the first embodiment, except for some differences in processing. The behavior determination unit 102b includes a drive plan unit 121 as a sub-functional block. The behavior determination unit 102b is similar to the behavior determination unit 102 of the first embodiment, except that the behavior determination unit 102b does not include the drive restriction unit 122 and the threshold change unit 123.

The anomaly specifying unit 108 specifies whether or not there is an anomaly in the autonomous driving of the vehicle. For example, the anomaly specifying unit 108 may specify whether or not there is an anomaly in the autonomous driving based on the degree of deviation between the drive plan and the driving control results according to the drive plan. As an example, if the degree of deviation is equal to or greater than a specific value, it may be determined that there is an anomaly in the autonomous driving. For example, the degree of deviation will increase when the load on vehicle components is applied as a result of continuation of the autonomous driving. The process in the anomaly specifying unit 108 corresponds to an anomaly specifying step.

The maintenance information acquisition unit 109 acquires information regarding the past maintenance executed on the vehicle (hereinafter, “maintenance information”). For example, the maintenance information may be the cumulative number of maintenance operations that have been executed on the vehicle in the past. The maintenance information may be stored in the ECU of the vehicle each time the maintenance is executed. The maintenance information acquisition unit 109 may be configured to acquire the maintenance information stored in the ECU.

The HCU communication unit 106b is the same as the HCU communication unit 106 of the first embodiment, except that some processing is different. The HCU communication unit 106b has an vehicle compartment notification processing unit 161b as a sub-functional block. The vehicle compartment notification processing unit 161b is similar to the vehicle compartment notification processing unit 161 of the first embodiment, except for some differences in processing. This different point will be described below.

The vehicle compartment notification processing unit 161b issues a normal notification when the continuation amount of the autonomous driving exceeds the continuation threshold and the anomaly specifying unit 108 specifies that there is no anomaly in the autonomous driving. The normal notification is made by the notification device 17. The continuation amount of the autonomous driving is determined by the continuation specifying unit 104. The continuation threshold may be the same as that described in the first embodiment. The normal notification is a notification that indicates that there is no difficulty with the vehicle even if the autonomous driving continues for a large continuation amount of the autonomous driving. The normal notification may be made by display on the display device 171 or by audio output from the sound output device 172. Even in cases where the autonomous driving continues for a large continuation amount of the autonomous driving, it is possible to reassure occupants by providing a normal notification. Therefore, even if the autonomous driving continues for a large continuation amount of the autonomous driving, if there is no anomaly in the autonomous driving, it is possible to reassure the occupants by notifying them of a normal state. As a result, it becomes possible to reduce the load on the occupant caused by continuing the autonomous driving for a long time or long distance. The process in the vehicle compartment notification processing unit 161b corresponds to a vehicle compartment notification processing step.

It may be preferable that the vehicle compartment notification processing unit 161b causes the notification device 17 to periodically issue a notification as to whether or not the maintenance is required based on the specification result of the maintenance specifying unit 105 while the vehicle is in the autonomous driving mode. The notification of the maintenance requirement may be the same as that described in the first embodiment. It may be preferable that the vehicle compartment notification processing unit 161b shortens the interval between notifications after the first notification of the maintenance requirement, compared to the interval from the start of the autonomous driving to the first notification of the maintenance requirement. For example, the first notification of the maintenance requirement may be given after 500 km of driving has continued since the start of the autonomous driving, and the second and subsequent notifications of the maintenance requirement may be given every 100 km of driving. This makes it possible to execute the notification of the maintenance requirement while reducing annoyance of the notification during periods when the possibility of the maintenance requirement is low. The vehicle compartment notification processing unit 161 of the first embodiment may also shorten the interval between notifications after the first notification of the maintenance requirement, compared to the interval from the start of the autonomous driving to the first notification of the maintenance requirement, and periodically execute the notification of the maintenance requirement.

It may be preferable that the vehicle compartment notification processing unit 161b changes the interval of the notification of the maintenance requirement, based on the maintenance information acquired by the maintenance information acquisition unit 109, and depending on the frequency of maintenance execution. The interval of the notification of the maintenance requirement is an interval at which notification is periodically executed. As one example, the interval between notifications of the maintenance requirement is shortened as the frequency of maintenance execution increases. According to the above configuration, it is possible to change the interval of the notification of the maintenance requirement depending on the degree of necessity of maintenance.

<Continuation Response Related Process in the Autonomous Driving ECU 10b>

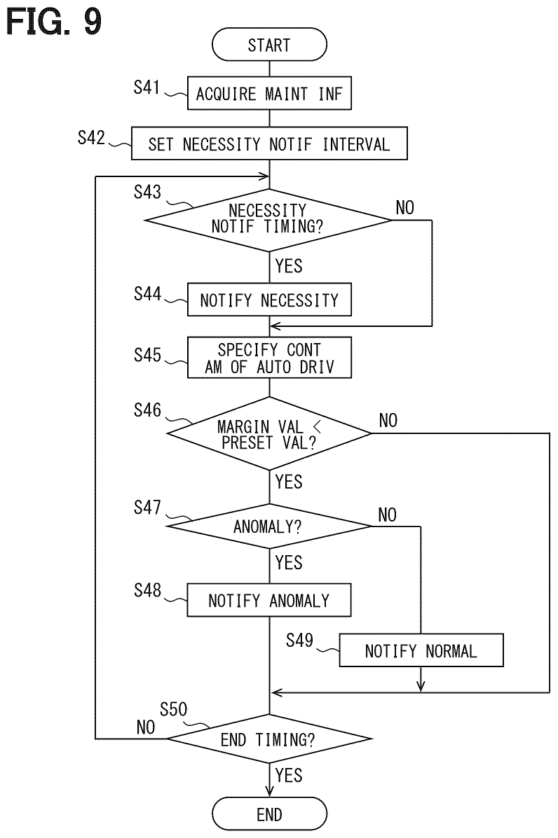

Here, an example of the flow of the continuation response related process in the autonomous driving ECU 10b will be described using the flowchart in FIG. 9. The flowchart in FIG. 9 may be configured to start when the subject vehicle starts driving by the autonomous driving.

First, in step S41, the maintenance information acquisition unit 109 acquires the maintenance information. In step S42, the vehicle compartment notification processing unit 161b sets the interval for notification of the maintenance requirement in accordance with the frequency of maintenance execution, based on the maintenance information acquired in S41.

First, in step S43, the vehicle compartment notification processing unit 161b determines whether or not it is time to execute the periodic notification of the maintenance requirement. If it is time to issue the periodic notification of the maintenance requirement (i.e., “YES” in S43), the process proceeds to step S44. On the other hand, if it is not the timing to issue the periodic notification of the maintenance requirement (i.e., “NO” in S43), the process proceeds to step S45. In step S44, the vehicle compartment notification processing unit 161b issue the periodic notification of the maintenance requirement.

In step S45, the continuation specifying unit 104 specifies the autonomous driving continuation amount. In step S46, the vehicle compartment notification processing unit 161b calculates a margin value, which is the difference between the autonomous driving continuation amount specified in S45 and a continuation threshold value. If the margin value is less than the predetermined value (“YES” in S46), the process proceeds to step S47. On the other hand, if the margin value is equal to or greater than the predetermined value (“NO” in S46), the process proceeds to step S50.

In step S47, the anomaly specifying unit 108 specifies whether or not there is an anomaly in the autonomous driving of the subject vehicle. If it is determined that there is an anomaly in the autonomous driving (“YES” in S47), the process proceeds to step S48. On the other hand, if it is determined that there is no anomaly in the autonomous driving (“NO” in S47), the process proceeds to step S49.

In step S48, the vehicle compartment notification processing unit 161b controls the notification device 17 to notify of an anomaly, and the process proceeds to step S50. An anomaly notification is a notification that indicates that there is a difficulty with the autonomous driving of the vehicle. The process of S48 may be omitted and no anomaly notification may be given. In this case, the feature that there was a difficulty with the autonomous driving of the vehicle is recorded as diagnostic information, but an anomaly notification is not issued. In step S49, the vehicle compartment notification processing unit 161b controls the notification device 17 to notify of an anomaly, and the process proceeds to step S50.

In step S50, if it is time to end the continuation response related process (“YES” in S50), the continuation response related process is ended. On the other hand, when it is not the end timing of the continuation response related process (“NO” in S50), the process returns to S43 and repeats the process. Examples of timings for ending the continuation response related process include ending of the autonomous driving, stopping of the subject vehicle, and the like.

The configuration of the third embodiment may be combined with the configurations of the first and second embodiments. In addition, it may be preferable that the configurations of the first to third embodiments are applied to autonomous driving vehicles that execute the autonomous driving of level 2 or higher. It may be preferable that the configurations of the first to third embodiments are applied to autonomous driving vehicles that execute the autonomous driving at level 3 or higher without the monitoring obligation of a driver or an operator. This is because the higher the level of automation of the autonomous driving, the less the driver has to be involved in driving, so that it is easier for the autonomous driving to continue over long distances and for long periods of time.

### FOURTH EMBODIMENT

The present disclosure is not limited to the configuration described in the above embodiment, but can also adopt the following configuration as a fourth embodiment. The following will describe a detailed example of the fourth embodiment with reference to the accompanying drawings.

<Schematic Configuration of Vehicle System 1c>

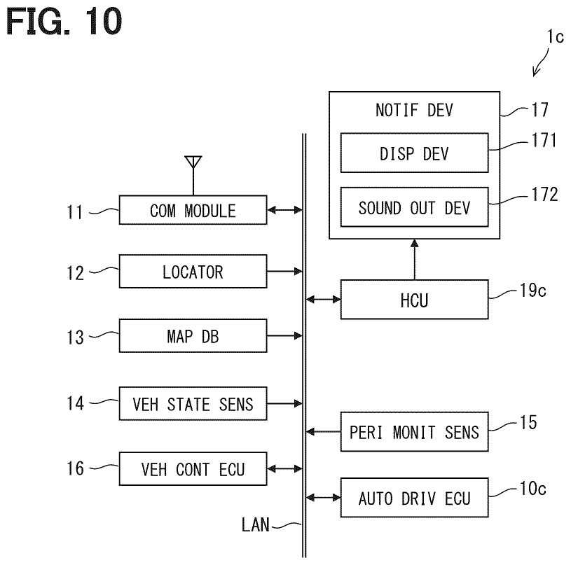

A vehicle system 1c shown in FIG. 10 can be used in an autonomous driving vehicle. As shown in FIG. 10, the vehicle system 1c includes an autonomous driving ECU 10c, a communication module 11, a locator 12, a map DB 13, a vehicle state sensor 14, a periphery monitoring sensor 15, a vehicle control ECU 16, a notification device 17, and an HCU 19c. The vehicle system 1c includes an autonomous driving ECU 10c instead of the autonomous driving ECU 10. The vehicle system 1c includes the HCU 19c instead of the HCU 19. The vehicle system 1c is similar to the vehicle system 1 of the first embodiment except for these points.

The HCU 19c is similar to the HCU 19 of the first embodiment, except for some differences in processing. This different point will be described below. The HCU 19c may also determine the physical condition of the occupant as the state of the occupant. The physical condition of the occupant may be determined by distinguishing, for example, whether the occupant is in good physical condition or not. The physical condition of the occupant may be determined using a learning device that has learned the relationship between the physical condition and the facial expression, posture, and the like of the occupant. The HCU 19c may determine whether the occupant is asleep or awake as the occupant's state. The HCU 19c may determine whether the occupant is asleep or awake, for example, from the degree to which the occupant's eyelids are open. The HCU 19c may determine, as the occupant's state, whether or not the occupant is monitoring the periphery. Hereinafter, the state in which the occupant is monitoring the periphery will be referred to as the “periphery monitoring state.” The HCU 19c may determine whether or not the occupant is monitoring the periphery based on, for example, the direction of the occupant's line of sight. The HCU 19c may determine, as the state of the occupant, whether or not the driver is executing the second task. The HCU 19c may determine, as the occupant state, whether or not an occupant other than the driver is executing an action corresponding to the second task. Hereinafter, a state in which the occupant is executing the second task or an action equivalent to the second task will be referred to as a second task state. The second task state corresponds to a state in which a specific action is being executed. The HCU 19c may determine whether or not the driver is in the second task state based on, for example, the driver's facial direction, a line of sight, a posture, and the like.

<Schematic Configuration of Autonomous Driving ECU 10c>

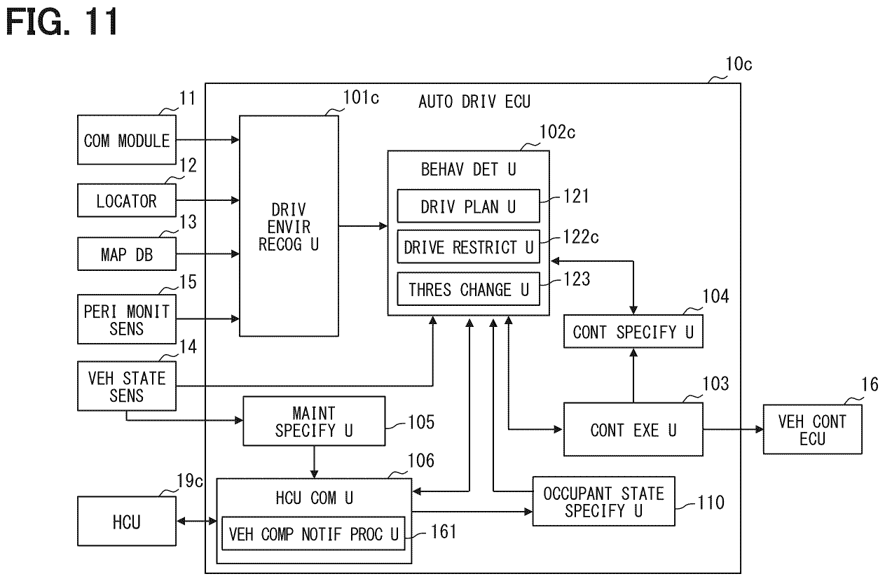

Next, a schematic configuration of the autonomous driving ECU 10c will be described with reference to FIG. 11. The autonomous driving ECU 10c is similar to the autonomous driving ECU 10 of the first embodiment, except for some differences in processing. The autonomous driving ECU 10c has a driving environment recognition unit 101c, a behavior determination unit 102c, a control execution unit 103, a continuation specifying unit 104, a maintenance specifying unit 105, an HCU communication unit 106, and an occupant state specifying unit 110 as functional blocks. The autonomous driving ECU 10c is equipped with a driving environment recognition unit 101c instead of the driving environment recognition unit 101. The autonomous driving ECU 10c includes a behavior determination unit 102c instead of the behavior determination unit 102. The autonomous driving ECU 10c is equipped with an occupant state specifying unit 110. Except for these points, the autonomous driving ECU 10c is similar to the autonomous driving ECU 10 of the first embodiment. The autonomous driving ECU 10c also corresponds to the vehicle control device. The execution of the processes of the functional blocks of the autonomous driving ECU 10c by the computer corresponds to execution of a vehicle control method.

The driving environment recognition unit 101c is similar to that of the autonomous driving ECU 10 of the first embodiment, except for some differences in processing. This different point will be described below. It may be preferable that the driving environment recognition unit 101c recognizes the lane in which the vehicle is driven, while also distinguishing which lane the vehicle is driven and how many lanes in each direction of the road.

The occupant state specifying unit 110 specifies the state of an occupant in the subject vehicle. The occupant state specifying unit 110 may specify the condition of the occupant acquired from the HCU 19c via the HCU communication unit 106 as the state of the occupant. In the present embodiment, the HCU 19c is used to specify the state of the occupant, but this is not necessarily limited to the above feature. For example, the occupant state specifying unit 110 may specify the state of the occupant from an image captured by the vehicle compartment camera 18 acquired via the HCU communication unit 106. The occupant state specifying unit 110 may specify the state of the occupant from an image other than that captured by the vehicle compartment camera 18. For example, the occupant state specifying unit 110 may estimate whether or not the occupant is executing the second task or an action equivalent to the second task from an input received by an operation device of the vehicle. As one example, it may be possible to determine that the occupant is executing the second task or an action equivalent to the second task based on the feature that an input is received from a touch switch integrated with the CID.

The behavior determination unit 102c is similar to the behavior determination unit 102 of the first embodiment, except for some differences in processing. The behavior determination unit 102c includes a drive plan unit 121, a drive restriction unit 122c, and a threshold change unit 123 as sub-functional blocks. The behavior determination unit 102c is similar to the behavior determination unit 102 of the first embodiment, except that the behavior determination unit 102c includes a drive restriction unit 122c instead of the drive restriction unit 122.

The drive restriction unit 122c is similar to the drive restriction unit 122 of the first embodiment, except for some differences in processing. This different point will be described below. The drive restriction unit 122c executes the following driving restrictions when the autonomous driving continuation amount specified by the continuation specifying unit 104 exceeds the above-described predetermined threshold. The drive restriction unit 122c switches between a timing drive restriction and an immediate drive restriction depending on at least one of the driving environment of the subject vehicle and the state of the driver of the subject vehicle. The timing drive restriction is a drive restriction that is executed after waiting for a predetermined timing. Hereinafter, this predetermined timing will be referred to as the restriction timing. The immediate drive restriction is a drive restriction that is executed without waiting for the restriction timing. The driving environment of the vehicle may be that recognized by the driving environment recognition unit 101c. The driver's state may be that acquired by the occupant state specifying unit 110.

Even if the continuation amount of the autonomous driving exceeds a predetermined threshold, depending on the driving environment of the vehicle and the state of the driver, selection between a case where the drive restriction is executed immediately and a case where the drive restriction is executed after waiting for a predetermined timing may be different. In contrast, with the above configuration, it is possible to start the drive restriction at a suitable timing depending on the driving environment of the vehicle and the state of the driver.

As a timing drive restriction, the drive restriction unit 122c may preferably execute the drive restriction after the subject vehicle moves from an overtaking lane to a non-overtaking lane on a road with multiple lanes in each direction. In this case, the restriction timing is the timing when the vehicle moves from an overtaking lane to a non-overtaking lane on a road with multiple lanes in each direction. The non-overtaking lane is a lane intended for the drive at slower speeds than a overtaking lane. The lane in which the vehicle is traveling and the number of lanes on each side of the road can be recognized by the driving environment recognition unit 101c. When the vehicle is traveling in a overtaking lane, the drive restriction unit 122c may execute the drive restriction after the vehicle moves from the overtaking lane to a non-overtaking lane. On the other hand, when the vehicle is traveling in a lane other than the overtaking lane of the road, the drive restriction unit 122c may immediately execute a drive restriction. In other words, the drive restriction may be executed at the time point as a trigger when the continuation amount of the autonomous driving exceeds the above-described predetermined threshold.

In an overtaking lane, where the speed of following vehicles is higher than in non-overtaking lanes, the drive restriction executed on the subject vehicle may be likely to obstruct the smooth driving of following vehicles. In contrast, with the above configuration, it is possible to restrict the driving of the subject vehicle only after the situation has become such that the smooth driving of the following vehicle is not likely to be obstructed. As a result, it is possible to reduce the load on the vehicle or occupants caused by continuing the autonomous driving for long periods of time or long distances, while making it less likely to obstruct the smooth driving of following vehicles.

Next, an example in which the drive restriction unit 122c changes the drive restriction between the timing drive restriction and the immediate drive restriction depending on the state of the occupant of the subject vehicle will be described below. The drive restriction unit 122c may use the state of the occupant specified by the occupant state specifying unit 110 as the state of the occupant.

It may be preferable that the drive restriction unit 122c uses a timing drive restriction in which, when the occupant is asleep or in poor physical condition, the drive restriction is executed after waiting for the occupant's state to improve. If the occupant was asleep, the occupant's state becoming awake may be regarded as an improvement in the occupant's state. In the case where the occupant was in poor physical condition, the occupant's state may be regarded as an improvement in the occupant's state when the occupant is no longer in poor physical condition. When the driving of the vehicle is restricted, the vehicle's behavior may change significantly or an exchange of driving operation may be required. It is easier to respond to these changes once the occupant's state has improved from a sleeping or poor physical condition. Therefore, according to the above configuration, it is possible to execute the drive restriction after the occupant is in a state where the occupant can easily respond to the driving restriction.

It may be preferable that the drive restriction unit 122c uses a timing drive restriction in which, when the occupant is not in a periphery monitoring state, the drive restriction unit 122c waits until the occupant is in a periphery monitoring state before executing the drive restriction. It is easier for the occupant to respond to the changes that occur when the drive restriction described above is executed when the occupant is in the periphery monitoring state than when the occupant is not in the periphery monitoring state. Therefore, with the above configuration, it is possible to execute the drive restriction after the occupant is in a state where the occupant can easily respond to the drive restriction.

It may be preferable that the drive restriction unit 122c uses a timing drive restriction that, when the occupant's state is in the second task state, executes the drive restriction after waiting until the occupant is no longer executing the second task or an action equivalent to the second task. It is easier for an occupant to respond to the changes that occur when the drive restriction described above is executed in a case where the occupant is not executing the second task or an action equivalent to the second task, than in a case where the occupant is in the second task state. Therefore, with the above configuration, it is possible to execute the drive restriction after the occupant is in a state where the occupant can easily respond to the drive restriction.

As a timing drive restriction, it may be preferable that the drive restriction unit 122c executes the drive restriction only after there are no more following vehicles within a predetermined range behind the subject vehicle. In this case, the restriction timing is the timing when there is no longer a following vehicle within a predetermined range behind the subject vehicle. The predetermined range referred to here may be arbitrarily set. The predetermined range may be, for example, the sensing range of the periphery monitoring sensor 15. When a following vehicle is disposed within the predetermined range, the drive restriction unit 122c may execute the drive restriction after the following vehicle is no longer disposed within the predetermined range. On the other hand, when there is no following vehicle within the predetermined range, the drive restriction unit 122c may immediately execute a drive restriction. In other words, when the continuation amount of the autonomous driving exceeds the above-described predetermined threshold, if there is no following vehicle within a predetermined range, the immediate drive restrictions may be executed.

When a following vehicle is disposed within a predetermined range behind the subject vehicle, the drive restriction executed on the subject vehicle is likely to obstruct the smooth driving of the following vehicle. On the other hand, when there is no following vehicle within a predetermined range behind the subject vehicle, the drive restriction executed on the subject vehicle is less likely to obstruct the smooth driving of the following vehicle than when there is a following vehicle. In contrast, with the above configuration, it is possible to restrict the driving of the subject vehicle only after the situation has become such that the smooth driving of the following vehicle is not likely to be obstructed. As a result, it is possible to reduce the load on the vehicle or occupants caused by continuing the autonomous driving for long periods of time or long distances, while making it less likely to obstruct the smooth driving of following vehicles.

The behavior determination unit 102c may determine evacuation behavior, such as evacuation to a service area, depending on the physical condition of the occupant. For example, when the occupant state specified by the occupant state specifying unit 110 is in poor physical condition of the occupant, evacuation behavior may be determined. When the behavior determination unit 102c determines that an evacuation behavior is to be executed, the drive plan unit 121 may determine a drive plan for evacuation from the current position to an evacuation area such as a service area.

### FIFTH EMBODIMENT

The present disclosure is not limited to the configuration described in the above embodiment, but can also adopt the following configuration as a fifth embodiment. The following will describe a detailed example of the fifth embodiment with reference to the accompanying drawings.

<Schematic Configuration of Vehicle System 1d>

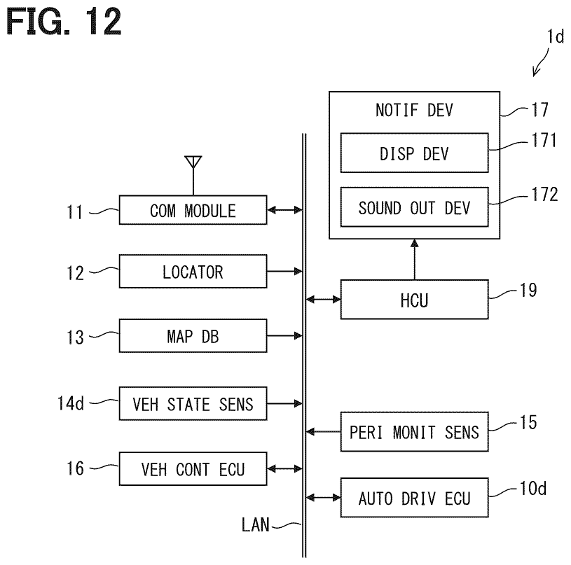

A vehicle system 1d shown in FIG. 12 can be used in an autonomous driving vehicle. As shown in FIG. 12, the vehicle system 1d includes an autonomous driving ECU 10d, a communication module 11, a locator 12, a map DB 13, a vehicle state sensor 14d, a periphery monitoring sensor 15, a vehicle control ECU 16, a notification device 17, and an HCU 19. The vehicle system 1d includes an autonomous driving ECU 10d instead of the autonomous driving ECU 10. The vehicle system 1d includes a vehicle state sensor 14d instead of the vehicle state sensor 14. The vehicle system 1d is similar to the vehicle system 1 of the first embodiment except for these points.

The vehicle state sensor 14d is similar to the vehicle state sensor 14 of the first embodiment, except for some differences in processing. This different point will be described below. The vehicle state sensor 14d may preferably also include a sensor capable of detecting information regarding the load of the vehicle. The information relating to the load of the vehicle is hereinafter referred to as load-related information. Examples of a sensor capable of detecting load-related information include a temperature sensor and an sound sensor. If the vehicle uses an engine as a driving source, the temperature sensor detects the engine temperature as the load-related information. The temperature sensor also detects the temperature of vehicle component other than the engine as load-related information. For example, the temperature of the vehicle body may be detected. The load on the vehicle is considered to be greater the further the engine temperature and the vehicle component temperature deviate from the center value of the appropriate temperature range. The sound sensor detects anomaly noise from the tires as the load-related information. The wear sensor detects the wear of the brake pads as the load-related information. The sound sensor may also function as a wear sensor.

<Schematic Configuration of Autonomous Driving ECU 10d>

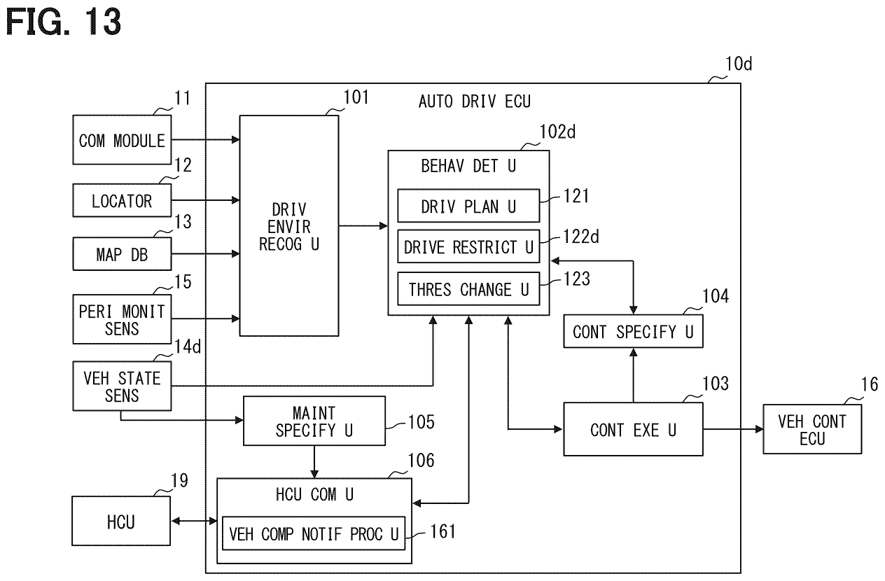

Next, a schematic configuration of the autonomous driving ECU 10d will be described with reference to FIG. 13. The autonomous driving ECU 10d is similar to the autonomous driving ECU 10 of the first embodiment, except for some differences in processing. The autonomous driving ECU 10d has a driving environment recognition unit 101, a behavior determination unit 102d, a control execution unit 103, a continuation specifying unit 104, a maintenance specifying unit 105, and an HCU communication unit 106 as functional blocks. The autonomous driving ECU 10d is similar to the autonomous driving ECU 10 of the first embodiment, except that the autonomous driving ECU 10d includes a behavior determination unit 102d instead of the behavior determination unit 102. The autonomous driving ECU 10d also corresponds to the vehicle control device. The execution of the processes of the functional blocks of the autonomous driving ECU 10d by the computer corresponds to execution of a vehicle control method.

The behavior determination unit 102d is similar to the behavior determination unit 102 of the first embodiment, except for some differences in processing. The behavior determination unit 102d includes a drive plan unit 121, a drive restriction unit 122d, and a threshold change unit 123 as sub-functional blocks. The behavior determination unit 102d is similar to the behavior determination unit 102 of the first embodiment, except that the behavior determination unit 102d includes a drive restriction unit 122d instead of the drive restriction unit 122.

The drive restriction unit 122d is similar to the drive restriction unit 122 of the first embodiment, except for some differences in processing. This different point will be described below. It may be preferable that the drive restriction unit 122d acquires the load-related information detected by the vehicle state sensor 14d. It may be preferable that the drive restriction unit 122d changes the ratio of periods of each mode when the full mode and the recovery mode are alternately repeated in accordance with the load-related information. Hereinafter, the period during which the full mode continues will be referred to as the normal period. Hereinafter, the period during which the recovery mode continues will be referred to as the recovery period.

Depending on the load on the vehicle, selection between a case where the ratio of the normal period of the full mode is higher and a case where the ratio of the recovery period of the recover mode is higher may be different. In contrast, with the above configuration, it is possible to set the ratio of the periods of each mode when the full mode and the recovery mode are alternately repeated in a more preferable ratio according to the load on the vehicle.

The drive restriction unit 122d may change the ratio of the recovery period to be higher than the normal period as the load on the subject vehicle estimated from the load-related information increases. In the recovery mode, the vehicle speed is kept low compared to the full mode, so the load on the vehicle is reduced. Therefore, according to the above configuration, the ratio of the recovery period to the normal period is changed to be higher as the load on the subject vehicle increases, making it possible to suppress the load on the subject vehicle. When the ratio of the recovery period is changed to be higher than the normal period, the ratio of the recovery period may be set to 100%. If the ratio of the recovery period is to be 100%, the repetition of the full mode and the recovery mode can be stopped. The load of the subject vehicle estimated from the load-related information may be divided into two stages, i.e., a high load and a low load. The load on the subject vehicle may be estimated from the load-related information by, for example, the drive restriction unit 122d. For example, the drive restriction unit 122d may estimate a low load when the temperature of the engine, vehicle body, and the like is within a threshold range, and may estimate a high load when the temperature is outside the threshold range. For example, the drive restriction unit 122d may estimate the load to be low when the anomaly tire noise is less than a threshold value, and may estimate the load to be high when the anomaly tire noise is equal to or greater than the threshold value. For example, the drive restriction unit 122d may estimate a low load when the wear on the brake pads is less than a threshold, and may estimate a high load when the wear on the brake pads is equal to or greater than the threshold. The threshold value referred to here may be a value that can be arbitrarily set for each piece of the load-related information.

### SIXTH EMBODIMENT

The present disclosure is not limited to the configuration described in the above embodiment, but can also adopt the following configuration as a sixth embodiment. The following will describe a detailed example of the sixth embodiment with reference to the accompanying drawings.

<Schematic Configuration of Vehicle System 1e>

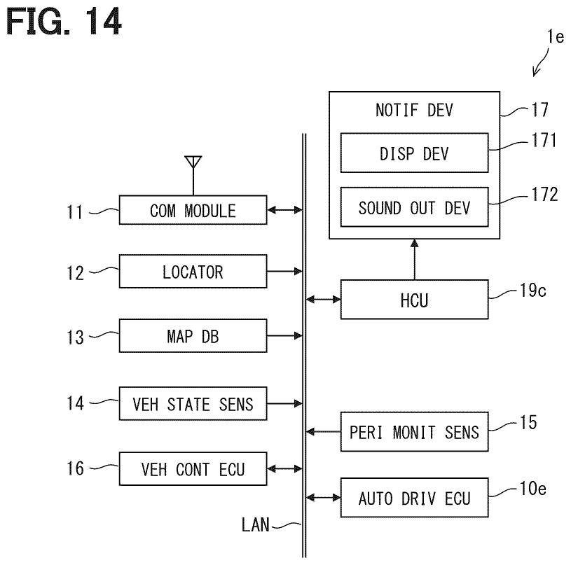

A vehicle system 1e shown in FIG. 14 can be used in an autonomous driving vehicle. As shown in FIG. 14, the vehicle system 1e includes an autonomous driving ECU 10e, a communication module 11, a locator 12, a map DB 13, a vehicle state sensor 14, a periphery monitoring sensor 15, a vehicle control ECU 16, a notification device 17, and an HCU 19c. The vehicle system 1e includes an autonomous driving ECU 10e instead of the autonomous driving ECU 10. The vehicle system 1e includes the HCU 19c instead of the HCU 19. The vehicle system 1e is similar to the vehicle system 1 of the first embodiment except for these points. The HCU 19c is similar to the HCU 19c in the fourth embodiment.

<Schematic Configuration of Autonomous Driving ECU 10e>

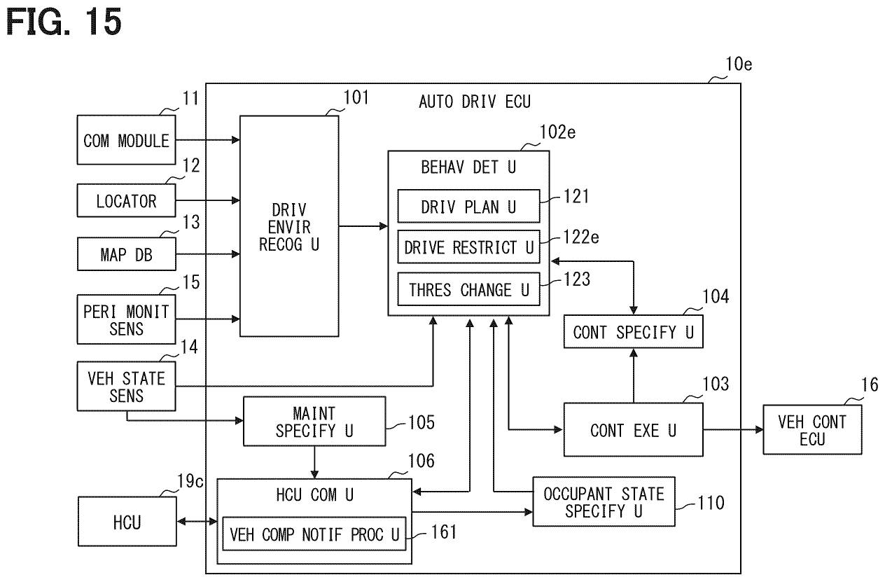

Next, a schematic configuration of the autonomous driving ECU 10e will be described with reference to FIG. 15. The autonomous driving ECU 10e is similar to the autonomous driving ECU 10 of the first embodiment, except for some differences in processing. The autonomous driving ECU 10e has a driving environment recognition unit 101, a behavior determination unit 102e, a control execution unit 103, a continuation specifying unit 104, a maintenance specifying unit 105, an HCU communication unit 106, and an occupant state specifying unit 110 as functional blocks. The autonomous driving ECU 10e includes a behavior determination unit 102e instead of the behavior determination unit 102. The autonomous driving ECU 10e is equipped with an occupant state specifying unit 110. The occupant state specifying unit 110 is the same as that described in the fourth embodiment. Except for these points, the autonomous driving ECU 10e is similar to the autonomous driving ECU 10 of the first embodiment. The autonomous driving ECU 10e also corresponds to the vehicle control device. The execution of the processes of the functional blocks of the autonomous driving ECU 10e by the computer corresponds to execution of a vehicle control method.

The behavior determination unit 102e is similar to the behavior determination unit 102 of the first embodiment, except for some differences in processing. The behavior determination unit 102e includes a drive plan unit 121, a drive restriction unit 122e, and a threshold change unit 123 as sub-functional blocks. The behavior determination unit 102e is similar to the behavior determination unit 102 of the first embodiment, except that the behavior determination unit 102e includes a drive restriction unit 122e instead of the drive restriction unit 122.

The drive restriction unit 122e is similar to the drive restriction unit 122 of the first embodiment, except for some differences in processing. It may be preferable that the drive restriction unit 122e changes the ratio between the normal period and the recovery period when the full mode and the recovery mode are alternately repeated, depending on the state of the occupant of the subject vehicle. The drive restriction unit 122e may use the state of the occupant specified by the occupant state specifying unit 110 as the state of the occupant.

Depending on the state of the occupant, selection between a case where the ratio of the normal period of the full mode is higher and a case where the ratio of the recovery period of the recover mode is higher may be different. In contrast, with the above configuration, it is possible to set the ratio of the periods of each mode when the full mode and the recovery mode are alternately repeated in a more preferable ratio according to the state of the occupant of the vehicle.

Examples of changes in the ratio between the normal period and the recovery period depending on the state of the occupant include the following feature. When the occupant is asleep or in poor physical condition, the drive restriction unit 122e may set the ratio of the recovery period to be greater than the normal period. In the recovery mode, the vehicle speed is kept lower than in full mode, so vehicle vibration is also reduced. Therefore, according to the above configuration, by suppressing vibrations of the vehicle, it is possible to make it difficult to disturb the occupant's sleep if the occupant is asleep, or to suppress the deterioration of the physical condition of the occupant if the occupant is in poor physical condition. When the ratio of the recovery period is changed to be higher than the normal period, the ratio of the recovery period may be set to 100%.

Furthermore, when the occupant's state is in the periphery monitoring state, the drive restriction unit 122e may set the ratio of the normal period to the recovery period to be greater. When the occupant is in a periphery monitoring state, the occupant is more likely to accept the large amount of the behavior of the vehicle. Therefore, according to the above configuration, it is possible to increase the ratio of the normal period only in a situation that the occupant can accept the large amount of the behavior of the vehicle in the moral mode.

Furthermore, when the occupant's state is in the second task state, the drive restriction unit 122e may set the ratio of the normal period to the recovery period to be greater. On the other hand, when the occupant's state is not in the second task state, the drive restriction unit 122e may increase the ratio of the recovery period compared to the normal period if the occupant's state is a state in which the occupant is not executing the second task or an action equivalent to the second task, or is in a resting posture. When the occupant is in the second task state, the occupant's attention is inclined toward the second task or an action equivalent to the second task, and therefore the occupant is more likely to accept the large amount of the behavior of the vehicle. On the other hand, when the occupant is a state in which the occupant is not executing the second task or an action equivalent to the second task, or is in a resting posture, it may be preferable that the vehicle behavior is small. Therefore, with the above configuration, it is possible to increase the ratio of the normal period when the situation is such that the occupant can easily accept the large amount of the behavior of the vehicle, while increasing the ratio of the recovery period when the situation is such that the occupant cannot easily accept the large amount of the behavior of the vehicle. When the ratio of the recovery period is changed to be higher than the normal period, the ratio of the recovery period may be set to 100%.

### SEVENTH EMBODIMENT

The present disclosure is not limited to the configuration described in the above embodiment, but can also adopt the following configuration as a seventh embodiment. The followings will describe an example of a configuration of the seventh embodiment with reference to the drawings.

<General Configuration of Vehicular System 1f>

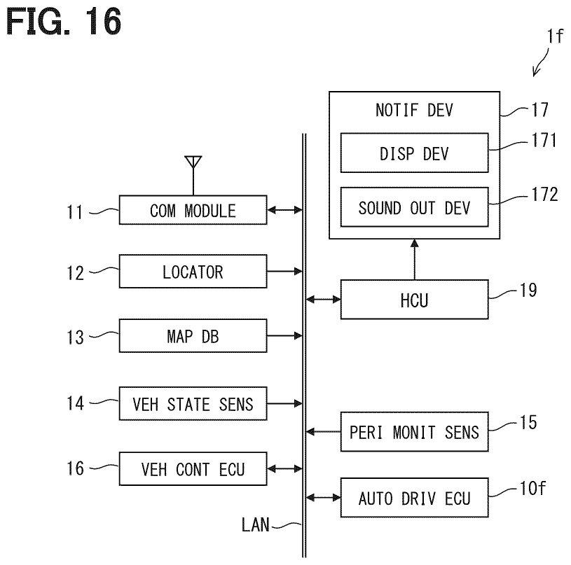

A vehicle system 1f shown in FIG. 16 can be used in an autonomous driving vehicle. As shown in FIG. 16, the vehicle system 1f includes an autonomous driving ECU 10f, a communication module 11, a locator 12, a map DB 13, a vehicle state sensor 14, a periphery monitoring sensor 15, a vehicle control ECU 16, a notification device 17, and an HCU 19. A vehicle system 1f of the seventh embodiment is similar to the vehicle system 1 of the first embodiment, except that the vehicle system 1f includes an autonomous driving ECU 10f instead of the autonomous driving ECU 10.

<General Configuration of Autonomous Driving ECU 10f>

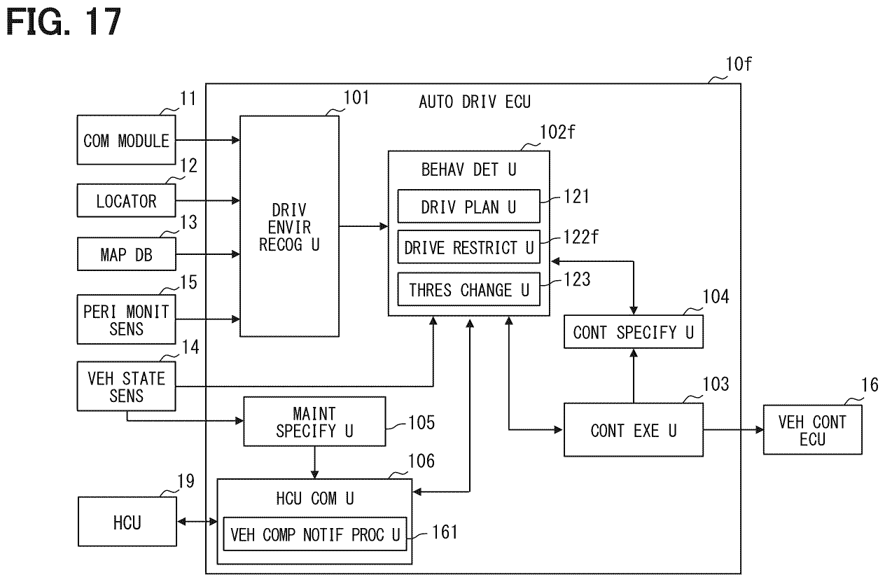

Next, a schematic configuration of the autonomous driving ECU 10f will be described with reference to FIG. 17. The autonomous driving ECU 10f is similar to the autonomous driving ECU 10 of the first embodiment, except for some differences in processing. The autonomous driving ECU 10f has a driving environment recognition unit 101, a behavior determination unit 102f, a control execution unit 103, a continuation specifying unit 104, a maintenance specifying unit 105, and an HCU communication unit 106 as functional blocks. The autonomous driving ECU 10f is similar to the autonomous driving ECU 10 of the first embodiment, except that the autonomous driving ECU 10f includes a behavior determination unit 102f instead of the behavior determination unit 102. The autonomous driving ECU 10f also corresponds to the vehicle control device. The execution of the processes of the functional blocks of the autonomous driving ECU 10f by the computer corresponds to execution of a vehicle control method.

The behavior determination unit 102f is similar to the behavior determination unit 102 of the first embodiment, except for some differences in processing. The behavior determination unit 102f includes a drive plan unit 121, a drive restriction unit 122f, and a threshold change unit 123 as sub-functional blocks. The behavior determination unit 102f is similar to the behavior determination unit 102 of the first embodiment, except that the behavior determination unit 102f includes a drive restriction unit 122f instead of the drive restriction unit 122.

The drive restriction unit 122f is similar to the drive restriction unit 122 of the first embodiment, except for some differences in processing. The drive restriction unit 122f restricts the subject vehicle to start driving in the recovery mode when the subject vehicle starts driving again within a first specific period after the vehicle has been driven a specific distance or more. “Driving a specific distance or more” refers to driving a specific distance or more without turning off the vehicle power. Hereinafter, driving that is equal to or longer than the specific distance will be referred to as long-distance driving. The specific distance referred to here is a distance where the load on the vehicle is estimated to be large, and is a value that can be set arbitrarily. The specific distance may be, for example, several hundred km. The first specific period is a period during which the temperatures of the vehicle components, such as the engine and the vehicle body, which have risen due to driving, are estimated to return to the temperatures before driving, and is a value that can be set arbitrarily. Hereinafter, the first specific period will be referred to as a short period. The first specific period may be, for example, one day or about 30 minutes.

When a vehicle starts driving again in a short period of time after driving a long distance, the load on the vehicle increases. According to the above configuration, in such a case, by restricting the vehicle from starting driving in the recovery mode, it is possible to further reduce the load on the vehicle side.

### EIGHTH EMBODIMENT

The present disclosure is not limited to the configuration described in the above embodiment, but can also adopt the following configuration as an eight embodiment. The following will describe a detailed example of the eighth embodiment with reference to the accompanying drawings.

<General Configuration of Vehicle System 1g>

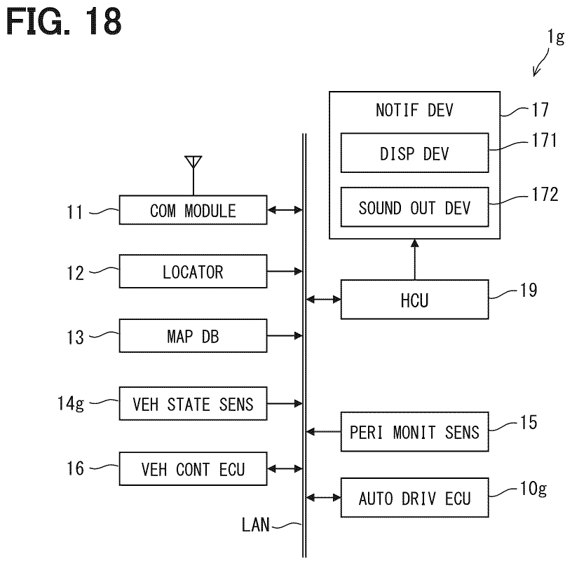

A vehicle system 1g shown in FIG. 18 can be used in an autonomous driving vehicle. As shown in FIG. 18, the vehicle system 1g includes an autonomous driving ECU 10g, a communication module 11, a locator 12, a map DB 13, a vehicle state sensor 14g, a periphery monitoring sensor 15, a vehicle control ECU 16, a notification device 17, and an HCU 19. The vehicle system 1g includes an autonomous driving ECU 10g instead of the autonomous driving ECU 10. The vehicle system 1g includes a vehicle state sensor 14g instead of the vehicle state sensor 14. The vehicle system 1g is similar to the vehicle system 1 of the first embodiment except for these points.

The vehicle state sensor 14g is similar to the vehicle state sensor 14 of the first embodiment, except for some differences in processing. This different point will be described below. The vehicle state sensor 14g also includes a weight sensor that can detect the weight of the cargo bed of the vehicle.

<General Configuration of Autonomous Driving ECU 10g>

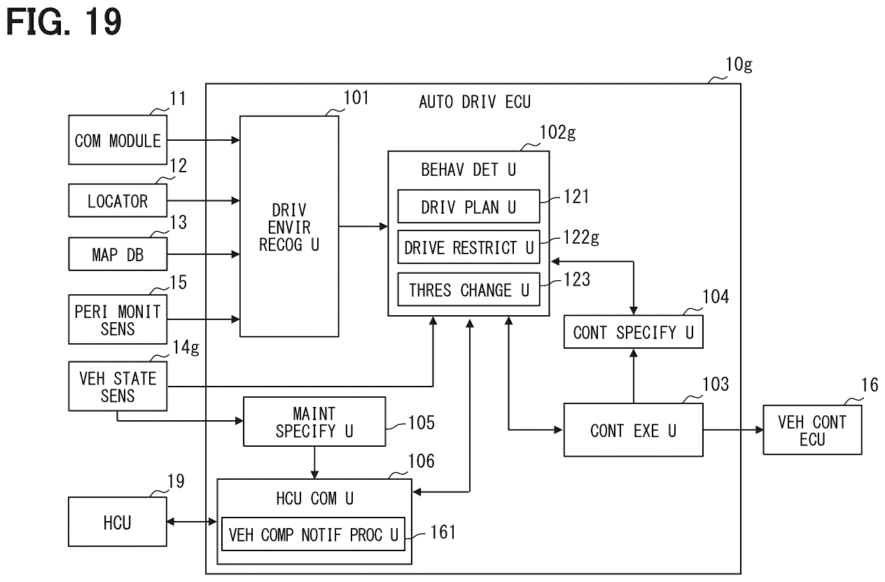

Next, a schematic configuration of the autonomous driving ECU 10g will be described with reference to FIG. 19. The autonomous driving ECU 10g is similar to the autonomous driving ECU 10 of the first embodiment, except for some differences in processing. The autonomous driving ECU 10g has a driving environment recognition unit 101, a behavior determination unit 102g, a control execution unit 103, a continuation specifying unit 104, a maintenance specifying unit 105, and an HCU communication unit 106 as functional blocks. The autonomous driving ECU 10g is similar to the autonomous driving ECU 10 of the first embodiment, except that the autonomous driving ECU 10g includes a behavior determination unit 102g instead of the behavior determination unit 102. The autonomous driving ECU 10g also corresponds to the vehicle control device. The execution of the processes of the functional blocks of the autonomous driving ECU 10g by the computer corresponds to execution of a vehicle control method.

The behavior determination unit 102g is similar to the behavior determination unit 102 of the first embodiment, except for some differences in processing. The behavior determination unit 102g includes a drive plan unit 121, a drive restriction unit 122g, and a threshold change unit 123 as sub-functional blocks. The behavior determination unit 102g is similar to the behavior determination unit 102 of the first embodiment, except that the behavior determination unit 102f includes a drive restriction unit 122g instead of the drive restriction unit 122.

The drive restriction unit 122g is similar to the drive restriction unit 122 of the first embodiment, except for some differences in processing. The drive restriction unit 122g changes the ratio between the normal period and the recovery period when the full mode and the recovery mode are alternately repeated, depending on the weight of the cargo bed of the subject vehicle. The drive restriction unit 122g may use the weight of the cargo bed acquired from the weight sensor of the vehicle state sensor 14g. When the weight of the cargo bed is equal to or greater than the first threshold value, the drive restriction unit 122g may set the ratio of the normal period to the recovery period to be greater. On the other hand, when the weight of the cargo bed is less than the second threshold value, the drive restriction unit 122g may increase the ratio of the recovery period compared to the normal period.

The first threshold value may be a weight at which the load on the vehicle is estimated to be high, and may be an arbitrarily settable value. The second threshold is less than or equal to the first threshold. The second threshold value may be the same as the first threshold value, but may also be a different value. The second threshold value may be a value that distinguishes whether or not there is luggage on the cargo bed, and may be a value that can be set arbitrarily. According to the above configuration, when the weight of the cargo bed is large and more power is required for driving, the ratio of the normal period can be increased, making it easier to drive. On the other hand, when the weight of the cargo bed is small and the power required for driving is smaller, the ratio of the recovery period can be increased, making it possible to further reduce the load on the vehicle. When the vehicle unloads a luggage and the weight of the cargo bed becomes smaller, the ratio of the recovery period can be increased, making it easier to recover from the load caused by the weight of the luggage.

### NINTH EMBODIMENT

The present disclosure is not limited to the configuration described in the above embodiment, but can also adopt the following configuration as an ninth embodiment. The following will describe a detailed example of the ninth embodiment with reference to the accompanying drawings.

<General Configuration of Vehicle System 1h>

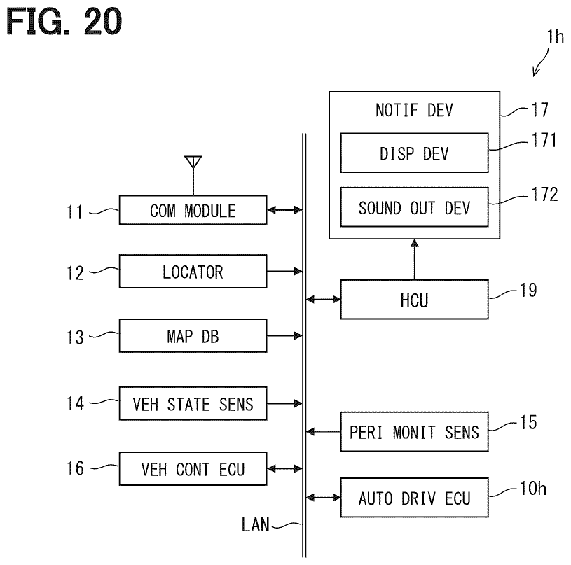

A vehicle system 1h shown in FIG. 20 can be used in an autonomous driving vehicle. As shown in FIG. 20, the vehicle system 1h includes an autonomous driving ECU 10h, a communication module 11, a locator 12, a map DB 13, a vehicle state sensor 14, a periphery monitoring sensor 15, a vehicle control ECU 16, a notification device 17, and an HCU 19. A vehicle system 1h of the ninth embodiment is similar to the vehicle system 1 of the first embodiment, except that the vehicle system 1h includes an autonomous driving ECU 10h instead of the autonomous driving ECU 10.

<General Configuration of Autonomous Driving ECU 10h>

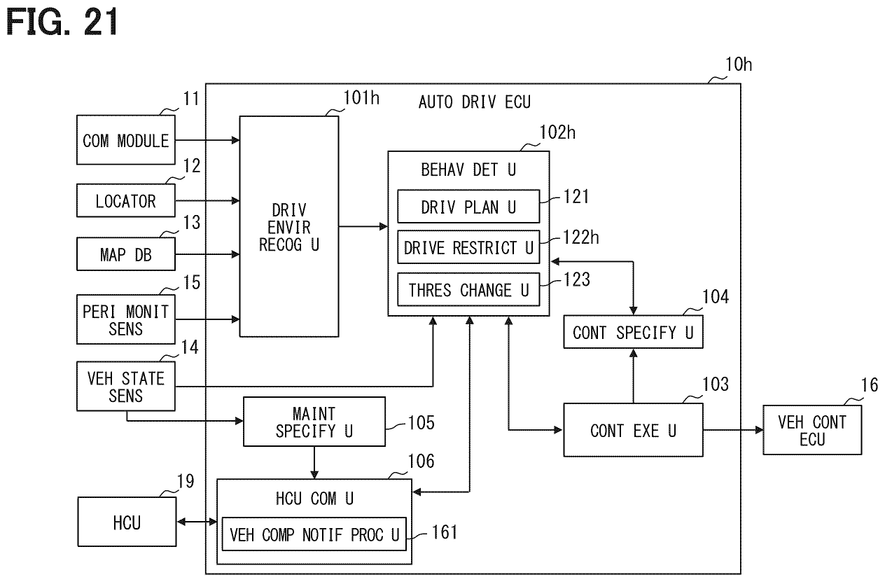

Next, a schematic configuration of the autonomous driving ECU 10h will be described with reference to FIG. 21. The autonomous driving ECU 10h is similar to the autonomous driving ECU 10 of the first embodiment, except for some differences in processing. The autonomous driving ECU 10h has a driving environment recognition unit 101h, a behavior determination unit 102h, a control execution unit 103, a continuation specifying unit 104, a maintenance specifying unit 105, and an HCU communication unit 106 as functional blocks. The autonomous driving ECU 10h is equipped with a driving environment recognition unit 101h instead of the driving environment recognition unit 101. The autonomous driving ECU 10h includes a behavior determination unit 102h instead of the behavior determination unit 102. Except for these points, the autonomous driving ECU 10h is the same as the autonomous driving ECU 10 of the first embodiment. The autonomous driving ECU 10h also corresponds to the vehicle control device. The execution of the processes of the functional blocks of the autonomous driving ECU 10h by the computer corresponds to execution of a vehicle control method.

The driving environment recognition unit 101h is similar to that of the autonomous driving ECU 10 of the first embodiment, except for some differences in processing. This different point will be described below. The driving environment recognition unit 101h recognizes the gradient of the road on which the vehicle is driving. The gradient of the road on which the vehicle is travelling is the gradient of the road section in the direction in which the vehicle is travelling among the road sections on which the vehicle is travelling. The driving environment recognition unit 101h may recognize whether the road on which the vehicle is travelling has an upward gradient or a downward gradient. In addition, if the longitudinal gradient is less than the specific value, it may be determined that there is no gradient. The specific value may be any value that can be set.

The behavior determination unit 102h is similar to the behavior determination unit 102 of the first embodiment, except for some differences in processing. The behavior determination unit 102h includes a drive plan unit 121, a drive restriction unit 122h, and a threshold change unit 123 as sub-functional blocks. The behavior determination unit 102h is similar to the behavior determination unit 102 of the first embodiment, except that the behavior determination unit 102h includes a drive restriction unit 122h instead of the drive restriction unit 122.

The drive restriction unit 122h is similar to the drive restriction unit 122 of the first embodiment, except for some differences in processing. The drive restriction unit 122h changes the ratio between the normal period and the recovery period when the full mode and the recovery mode are alternately repeated, depending on the gradient of the driving road of the subject vehicle. The drive restriction unit 122h may use the gradient of the road recognized by the driving environment recognition unit 101d. When the road has a downward gradient, the drive restriction unit 122h may set the ratio of the recovery period to be greater than the normal period. On the other hand, when the road has an upward gradient, the drive restriction unit 122h may set the ratio of the normal period to be greater than the recovery period.

According to the above configuration, when the road on which the subject vehicle is travelling has an upward gradient and more power is required for driving, the ratio of the normal period can be increased, making it easier to drive. On the other hand, when the road on which the subject vehicle is travelling has a downward gradient and less power is required for driving, the ratio of the recovery period can be increased, thereby making it possible to further reduce the load on the vehicle. When the vehicle travels on the road with the downward gradient after driving on the road with upward gradient, the ratio of the recovery period can be increased, making it easier to recover from the load caused by driving on the road with the upward gradient. In addition, when there is no gradient, for example, the ratio between the normal period and the recovery period may be left at the default ratio. Alternatively, for example, even when there is no gradient, the ratio of the recovery period to the normal period may be made greater.

### TENTH EMBODIMENT

The present disclosure is not limited to the configuration described in the above embodiment, but can also adopt the following configuration as a tenth embodiment. The following will describe a detailed example of the tenth embodiment with reference to the accompanying drawings.

<General Configuration of Vehicle System 1i>

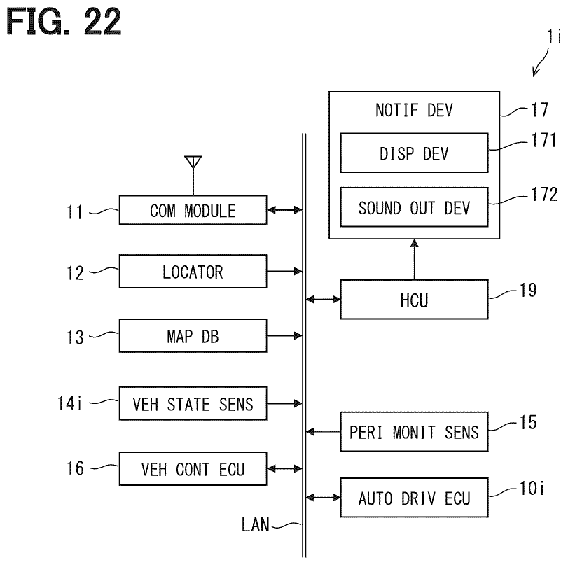

A vehicle system 1i shown in FIG. 22 can be used in an autonomous driving vehicle. As shown in FIG. 22, the vehicle system 1i includes an autonomous driving ECU 10i, a communication module 11, a locator 12, a map DB 13, a vehicle state sensor 14i, a periphery monitoring sensor 15, a vehicle control ECU 16, a notification device 17, and an HCU 19. A vehicle system 1i of the tenth embodiment is similar to the vehicle system 1 of the first embodiment, except that the vehicle system 1i includes an autonomous driving ECU 10i instead of the autonomous driving ECU 10.

The vehicle state sensor 14i is similar to the vehicle state sensor 14 of the first embodiment, except for some differences in processing. This different point will be described below. The vehicle state sensor 14i also includes a battery sensor that detects battery information of the vehicle's battery. The battery sensor may detect the voltage, current, temperature, and the like of the battery.

<General Configuration of Autonomous Driving ECU 10i>

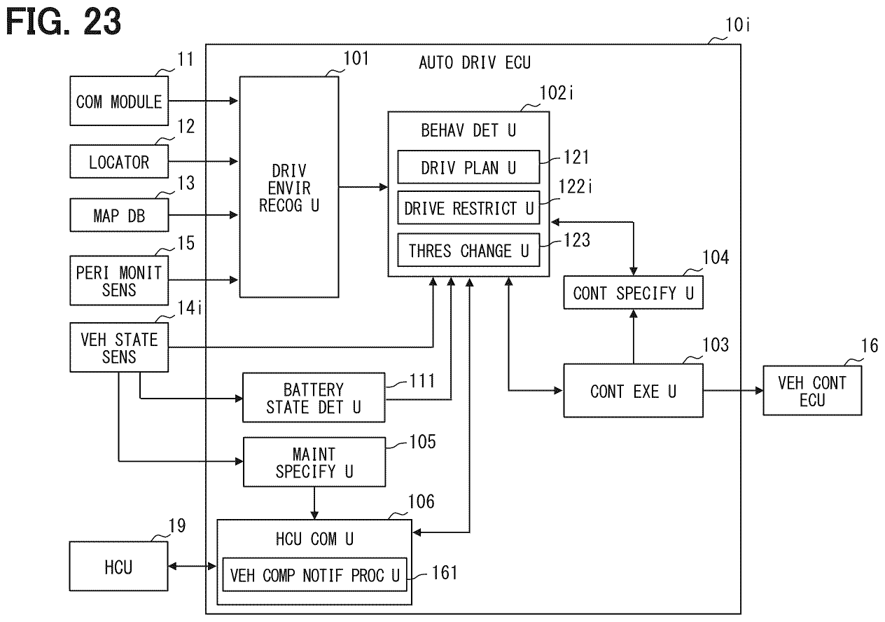

Next, a schematic configuration of the autonomous driving ECU 10i will be described with reference to FIG. 23. The autonomous driving ECU 10i is similar to the autonomous driving ECU 10 of the first embodiment, except for some differences in processing. The autonomous driving ECU 10i has a driving environment recognition unit 101, a behavior determination unit 102i, a control execution unit 103, a continuation specifying unit 104, a maintenance specifying unit 105, an HCU communication unit 106, and a battery state determination unit 111 as functional blocks. The autonomous driving ECU 10i includes a behavior determination unit 102i instead of the behavior determination unit 102. The autonomous driving ECU 10i includes a battery state determination unit 111. Except for these points, the autonomous driving ECU 10i is the same as the autonomous driving ECU 10 of the first embodiment. The autonomous driving ECU 10i also corresponds to the vehicle control device. The execution of the processes of the functional blocks of the autonomous driving ECU 10i by the computer corresponds to execution of a vehicle control method.

The battery state determination unit 111 determines the state of the battery of the vehicle. The battery state determination unit 111 specifies the deterioration state of the battery from the battery information detected by a battery sensor among the vehicle state sensors 14i. For example, the battery state determination unit 111 specifies the state of health (i.e., SOH) as the deterioration state. Then, the battery state determination unit 111 determines whether or not the battery is in a good condition based on the specified deterioration state. For example, the battery state determination unit 111 may determine whether the battery is in a good condition based on whether the battery's State of Health (i.e., SOH) is equal to or greater than a specific value. The specific value is a value for distinguishing whether the battery is in the good condition or not, and may be arbitrarily set. The specific value may be, for example, 70% to 80%.

The behavior determination unit 102i is similar to the behavior determination unit 102 of the first embodiment, except for some differences in processing. The behavior determination unit 102i includes a drive plan unit 121, a drive restriction unit 122i, and a threshold change unit 123 as sub-functional blocks. The behavior determination unit 102i is similar to the behavior determination unit 102 of the first embodiment, except that the behavior determination unit 102i includes a drive restriction unit 122i instead of the drive restriction unit 122.

The drive restriction unit 122i is similar to the drive restriction unit 122 of the first embodiment, except for some differences in processing. When the vehicle is to start driving again after having been suspended from the driving continuously for a second specific period or longer, the drive restriction unit 122i restricts the vehicle to start driving in the recovery mode or in the manual driving mode. The second specific period referred to here is a period during which the load on the vehicle is estimated to be large when the vehicle is to start driving again. Hereinafter, a period equal to or longer than the second specific period will be referred to as a long period. The second specific period may be, for example, one month. For example, the restriction on starting driving in the recovery mode may be such that the vehicle automatically starts driving in the recovery mode when driving starts. For example, the restriction on starting driving from the manual driving mode may be such that driving cannot be started unless the driving is switched to the manual driving mode.

When a vehicle is restarted after being stopped for a long period of time, the load on the vehicle may become large. According to the above configuration, in such a case, by restricting the vehicle from starting driving in the recovery mode or in the manual driving mode, it is possible to further reduce the load on the vehicle side.

It may be preferable that the drive restriction unit 122i executes the following operations after restricting the vehicle to start driving in the recovery mode or the manual driving mode and then starting driving. It may be preferable that the drive restriction unit 122i switches to the full mode when it is determined that the battery of the subject vehicle is in a good condition. Whether the battery is in a good condition or not can be determined using the determination result from the battery state determination unit 111.

If the battery is not in a good condition, it may be preferable to reduce the load on the vehicle in order to continue driving. On the other hand, when the battery is in a good condition, ease of driving is likely to take priority over reducing the load on the vehicle. In contrast, with the above configuration, when the state of the vehicle is such that ease of driving is more important than reducing the load on the vehicle, it is possible to switch to the full mode to make driving easier.

### ELEVENTH EMBODIMENT

In the above-described embodiment, the autonomous driving ECUs 10, 10a, 10b, 10c, 10d, 10e, 10f, 10g, 10h, and 10i correspond to a vehicle control device, but this is not necessarily limited to this feature. For example, an ECU other than the autonomous driving ECUs 10, 10a, 10b, 10c, 10d, 10e, 10f, 10g, 10h, and 10i may be configured to correspond to the vehicle control device.

### (Technical Features Described Above)

This specification discloses multiple technical ideas described in multiple items listed below. Some features may be described in a multiple dependent form, in which subsequent features alternatively refer to preceding features. Some features may be described in a multiple dependent form referring to another multiple dependent form. These features described in a multiple dependent form define multiple technical features.

### (Technical Feature 1)

A vehicle control device can be used in a vehicle that executes an autonomous driving. The vehicle control device includes: at least one of (i) a circuit and (ii) a processor having a memory storing computer program code. The at least one of the circuit and the processor having the memory is configured to cause the vehicle control device to provide at least one of: a continuation specifying unit; and a drive restriction unit. The continuation specifying unit that specifies a continuation amount of the autonomous driving, which is a continuous driving time or a continuous driving distance of the vehicle in the autonomous driving; and the drive restriction unit executes a drive restriction, which is a restriction on a driving operation in the autonomous driving, when the continuation amount of the autonomous driving specified by the continuation specifying unit exceeds a predetermined threshold.

### (Technical Feature 2)

In the vehicle control device according to the technical feature 1, the drive restriction unit executes the drive restriction at a timing when a behavior of the vehicle is low.

### (Technical Feature 3)

In the vehicle control device according to the technical feature 1 or 2, the drive restriction unit switches between a timing drive restriction and an immediate drive restriction as the drive restriction according to at least one of an driving environment of the vehicle and a state of a driver of the vehicle when the continuation amount of the autonomous driving specified by the continuation specifying unit exceeds the predetermined threshold. In the timing drive restriction, the drive restriction is executed after waiting for a predetermined timing. In the immediate drive restriction, the drive restriction is executed without waiting for the predetermined timing.

### (Technical Feature 4)

In the vehicle control device according to the technical feature 3, the drive restriction unit executes the immediate drive restriction when the vehicle is travelling in a lane other than an overtaking lane on a road with a plurality of lanes in each direction. When the vehicle is traveling in the overtaking lane of the road with the plurality of lanes in each direction, the drive restriction unit executes the timing drive restriction for executing the drive restriction after the vehicle moves from the overtaking lane to the lane other than the overtaking lane.

### (Technical Feature 5)

In the vehicle control device according to the technical feature 3 or 4, the drive restriction unit switches between the timing drive restriction and the immediate drive restriction according to a state of an occupant of the vehicle. The drive restriction unit executes the timing drive restriction for executing the drive restriction after waiting for the state of the occupant to be improved when the state of the occupant is in an asleep state or in a poor physical condition.

### (Technical Feature 6)

In the vehicle control device according to the technical feature 3 or 4, the drive restriction unit switches between the timing drive restriction and the immediate drive restriction according to a state of an occupant of the vehicle. The drive restriction unit executes the timing drive restriction for executing the drive restriction after waiting for the state of the occupant that is in a state where the occupant is monitoring the periphery of the vehicle when the state of the occupant is in a state where the occupant is not monitoring a periphery of the vehicle.

### (Technical Feature 7)

In the vehicle control device according to the technical feature 3 or 4, the drive restriction unit switches between the timing drive restriction and the immediate drive restriction according to a state of an occupant of the vehicle. The drive restriction unit executes the timing drive restriction for executing the drive restriction after waiting for the state of the occupant is in a state where the occupant is not executing the specific action when the state of the occupant is in a state where the occupant is executing a specific action during the autonomous driving without an obligation to monitor the periphery. The specific action is either a second task as an action other than driving operation or an action equivalent to the second task, and is allowable for a driver of the vehicle during the autonomous driving without an obligation to monitor the periphery.

### (Technical Feature 8)

In the vehicle control device according to any one of the technical features 3 to 7, the drive restriction unit executes the immediate drive restriction when there is no following vehicle within a predetermined range behind the vehicle. The drive restriction unit executes the timing drive restriction for executing the drive restriction after the following vehicle is not disposed within the predetermined range behind the vehicle when there is the following vehicle within the predetermined range behind the vehicle.

### (Technical Feature 9)

In the vehicle control device according to any one of the technical features 1 to 8, the drive restriction unit executes the drive restriction by repeatedly switching between a full mode in which the vehicle is travelling at a predetermined vehicle speed for the autonomous driving and a recovery mode in which the vehicle is travelling at a vehicle speed restricted to be lower than the predetermined vehicle speed for the autonomous driving when the continuation amount of the autonomous driving specified by the continuation specifying unit exceeds the predetermined threshold.

### (Technical Feature 10)

The vehicle control device according to any one of the technical features 1 to 9, further includes: an vehicle compartment notification processing unit that issues a notification to an occupant of the vehicle. The vehicle compartment notification processing unit issues the notification to the occupant of the vehicle suggesting a rest when a difference between the continuation amount of the autonomous driving specified by the continuation specifying unit and the predetermined threshold becomes less than a set value. The vehicle compartment notification processing unit issues the notification to the occupant of the vehicle to execute the drive restriction if the occupant of the vehicle does not take a rest.

### (Technical Feature 11)

The vehicle control device according to any one of the technical features 1 to 10, further includes: an vehicle compartment notification processing unit that issues a notification to an occupant of the vehicle. The vehicle compartment notification processing unit issues the notification to an occupant of the vehicle to prompt the occupant to check the vehicle when a difference between the continuation amount of the autonomous driving specified by the continuation specifying unit and the predetermined threshold becomes less than a set value.

### (Technical Feature 12)

The vehicle control device according to any one of the technical features 1 to 11, further includes: an vehicle compartment notification processing unit that issues a notification to an occupant of the vehicle; and a maintenance specifying unit that specifies whether the vehicle requires maintenance. The vehicle compartment notification processing unit periodically issues a necessity notification to the occupant of the vehicle whether the vehicle requires the maintenance based on a specifying result of the maintenance specifying unit during the autonomous driving of the vehicle.

### (Technical Feature 13)

The vehicle control device according to any one of the technical features 1 to 12, further includes: a drive plan unit that determines a drive plan for the autonomous driving of the vehicle. The drive plan unit determines the drive plan in which the vehicle travels along a route that passes through a location where maintenance of the vehicle can be executed when determining the drive plan in which the continuation amount of the autonomous driving of the vehicle is scheduled to reach a specific amount.

### (Technical Feature 14)

In the vehicle control device according to any one of the technical features 1 to 13, the vehicle is a remote control vehicle that is capable of executing the autonomous driving by a remote control operation. The vehicle control device further includes: a center notification processing unit that issues a notification to a remote operator of a monitoring center who remotely controls the vehicle. The center notification processing unit issues the notification to the remote operator suggesting a rest when a difference between the continuation amount of the autonomous driving specified by the continuation specifying unit and the predetermined threshold becomes less than a set value, and the vehicle is being autonomously driven by the remote control operation. The center notification processing unit issues the notification to the remote operator to execute the drive restriction if the remote operator does not take a rest.

### (Technical Feature 15)

In the vehicle control device according to any one of the technical features 1 to 14, the vehicle is a remote control vehicle that is capable of executing the autonomous driving by a remote control operation. The vehicle control device further includes: a center notification processing unit that issues a notification to a remote operator of a monitoring center who remotely controls the vehicle. The center notification processing unit issues the notification to the remote operator suggesting an exchange in the remote control operation when a difference between the continuation amount of the autonomous driving specified by the continuation specifying unit and the predetermined threshold becomes less than a set value, and the vehicle is being autonomously driven by the remote control operation.

### (Technical Feature 16)

The vehicle control device according to any one of the technical features 1 to 15, further includes: a driving environment specifying unit that specifies a driving environment of the vehicle; and a threshold change unit that changes the predetermined threshold to be smaller as the driving environment specified by the driving environment specifying unit becomes a worse condition for driving the vehicle.

### (Technical Feature 17)

In the vehicle control device according to any one of the technical features 1 to 16, the drive restriction unit executes the drive restriction by driving the vehicle to restrict a vehicle speed to be lower than a set vehicle speed for the autonomous driving when the continuation amount of the autonomous driving specified by the continuation specifying unit exceeds the predetermined threshold.

### (Technical Feature 18)

In the vehicle control device according to any one of the technical features 9 to 17, the drive restriction unit changes a ratio between a normal period and a recovery period according to load related information that is information related to a load on the vehicle when repeating a full mode in which the vehicle is travelling at a predetermined vehicle speed for the autonomous driving and a recovery mode in which the vehicle is travelling at a vehicle speed restricted to be lower than the predetermined vehicle speed for the autonomous driving. The normal period is a period during which the full mode continues, and the recovery period is a period during which the recovery mode continues.

### (Technical Feature 19)

In the vehicle control device according to any one of the technical features 9 to 18, the drive restriction unit changes a ratio between a normal period and a recovery period according to a state of an occupant of the vehicle when repeating a full mode in which the vehicle is travelling at a predetermined vehicle speed for the autonomous driving and a recovery mode in which the vehicle is travelling at a vehicle speed restricted to be lower than the predetermined vehicle speed for the autonomous driving. The normal period is a period during which the full mode continues, and the recovery period is a period during which the recovery mode continues.

### (Technical Feature 20)

In the vehicle control device according to the technical feature 19, the drive restriction unit increases the ratio of the recovery period compared to the normal period when the state of the occupant of the vehicle is in an asleep state or in a poor physical condition.

### (Technical Feature 21)

In the vehicle control device according to the technical feature 19, the drive restriction unit increases the ratio of the normal period compared with the recovery period when the state of the occupant of the vehicle is a state in which the occupant is monitoring a periphery of the vehicle.

### (Technical Feature 22)

In the vehicle control device according to the technical feature 19, the drive restriction unit increases the ratio of the normal period compared with the recovery period when the state of the occupant of the vehicle is in a state where the occupant is executing a specific action during the autonomous driving without an obligation to monitor a periphery of the vehicle. The specific action is either a second task as an action other than driving operation or an action equivalent to the second task, and is allowable for a driver of the vehicle during the autonomous driving without an obligation to monitor the periphery. The drive restriction unit increases the ratio of the recovery period compared with the normal period when the state of the occupant of the vehicle is in a state where the occupant is not executing the specific action or in a state where the occupant is in a rest posture.

### (Technical Feature 23)

In the vehicle control device according to any one of the technical features 9 to 22, the drive restriction unit executes the drive restriction to start driving in a recovery mode when the vehicle starts driving again within a predetermined short period of time as a first specific period after driving a long distance that is greater than or equal to a specific distance. In the recovery mode, the vehicle is travelling at a vehicle speed restricted to be lower than a predetermined vehicle speed for the autonomous driving.

### (Technical Feature 24)

In the vehicle control device according to any one of the technical features 9 to 23, the drive restriction unit increases a ratio of a normal period compared with a recovery period when a weight of a cargo bed of the vehicle is equal to or greater than a first threshold value when repeating a full mode in which the vehicle is travelling at a predetermined vehicle speed for the autonomous driving and a recovery mode in which the vehicle is travelling at a vehicle speed restricted to be lower than the predetermined vehicle speed for the autonomous driving. The normal period is a period during which the full mode continues, and the recovery period is a period during which the recovery mode continues. The drive restriction unit increases the ratio of the recovery period compared with the normal period when the weight of the cargo bed of the vehicle is less than a second threshold value that is equal to or less than the first threshold value.

### (Technical Feature 25)

In the vehicle control device according to any one of the technical features 9 to 24, the drive restriction unit increases a ratio of a recovery period compared with a normal period when the vehicle is travelling on a road with a downward slope when repeating a full mode in which the vehicle is travelling at a predetermined vehicle speed for the autonomous driving and a recovery mode in which the vehicle is travelling at a vehicle speed restricted to be lower than the predetermined vehicle speed for the autonomous driving. The normal period is a period during which the full mode continues, and the recovery period is a period during which the recovery mode continues. The drive restriction unit increases the ratio of the normal period compared with the recovery period when the vehicle is travelling on the road with an upward slope.

### (Technical Feature 26)

In the vehicle control device according to any one of the technical features 9 to 25, the drive restriction unit executes the drive restriction to start driving in a recovery mode or a manual driving mode when the vehicle starts driving again after continuously suspending to drive the vehicle for a long period of time that is equal to or longer than a second specific period. In the recovery mode, the vehicle is travelling at a vehicle speed restricted to be lower than the predetermined vehicle speed for the autonomous driving.

### (Technical Feature 27)

In the vehicle control device according to the technical feature 26, the drive restriction unit switches to a full mode when determining that a battery of the vehicle is in a healthy state after the vehicle starts travelling by executing the drive restriction to start driving in a recovery mode or a manual driving mode. In the full mode, the vehicle is travelling at a predetermined vehicle speed for the autonomous driving. In the recovery mode, the vehicle is travelling at a vehicle speed restricted to be lower than the predetermined vehicle speed for the autonomous driving.

Note that the present disclosure is not limited to the embodiments described above and can variously be modified within the scope of the present disclosure. An embodiment obtained by appropriately combining the technical features disclosed in different embodiments may also be included in the technical scope of the present disclosure. Further, the control unit and the method thereof described in the present disclosure may be implemented by a dedicated computer which includes a processor programmed to perform one or more functions executed by a computer program. Alternatively, the processing unit and the method thereof according to the present disclosure may be implemented by a dedicated hardware logic circuit. Alternatively, the device and the method thereof described in the present disclosure may also be implemented by one or more dedicated computers configured as a combination of a processor executing a computer program and one or more hardware logic circuits. The computer program may also be stored on a computer-readable and non-transitory tangible storage medium as an instruction executed by a computer.

It is noted that a flowchart or the processing of the flowchart in the present application includes sections (also referred to as steps), each of which is represented, for instance, as S1. Further, each section can be divided into several sub-sections while several sections can be combined into a single section. Furthermore, each of thus configured sections can be also referred to as a device, module, or means.

While the present disclosure has been described with reference to embodiments thereof, it is to be understood that the disclosure is not limited to the embodiments and constructions. The present disclosure is intended to cover various modification and equivalent arrangements. In addition, while the various combinations and configurations, other combinations and configurations, including more, less or only a single element, are also within the spirit and scope of the present disclosure.

What is claimed is:

1. A vehicle control device usable for a vehicle that executes an autonomous driving, the vehicle control device comprising:
a continuation specifying unit that specifies a continuation amount of the autonomous driving, which is a continuous driving time or a continuous driving distance of the vehicle in the autonomous driving; and
a drive restriction unit that executes a drive restriction, which is a restriction on a driving operation in the autonomous driving, when the continuation amount of the autonomous driving specified by the continuation specifying unit exceeds a predetermined threshold.

2. The vehicle control device according to claim 1, wherein:
the drive restriction unit executes the drive restriction at a timing when a behavior of the vehicle is low.

3. The vehicle control device according to claim 1, wherein:
the drive restriction unit switches between a timing drive restriction and an immediate drive restriction as the drive restriction according to at least one of an driving environment of the vehicle and a state of a driver of the vehicle when the continuation amount of the autonomous driving specified by the continuation specifying unit exceeds the predetermined threshold;
the drive restriction in the timing drive restriction is executed after waiting for a predetermined timing; and
the drive restriction in the immediate drive restriction is executed without waiting for the predetermined timing.

4. The vehicle control device according to claim 3, wherein:
the drive restriction unit executes the immediate drive restriction when the vehicle is travelling in a lane other than an overtaking lane on a road with a plurality of lanes in each direction; and
the drive restriction unit executes the timing drive restriction for executing the drive restriction after the vehicle moves from the overtaking lane to the lane other than the overtaking lane when the vehicle is traveling in the overtaking lane of the road with the plurality of lanes in each direction.

5. The vehicle control device according to claim 3, wherein:
the drive restriction unit switches between the timing drive restriction and the immediate drive restriction according to a state of an occupant of the vehicle; and
the drive restriction unit executes the timing drive restriction for executing the drive restriction after waiting for the state of the occupant to be improved when the state of the occupant is in an asleep state or in a poor physical condition.

6. The vehicle control device according to claim 3, wherein:
the drive restriction unit switches between the timing drive restriction and the immediate drive restriction according to a state of an occupant of the vehicle; and
the drive restriction unit executes the timing drive restriction for executing the drive restriction after waiting for the state of the occupant that is in a state where the occupant is monitoring a periphery of the vehicle when the state of the occupant is in a state where the occupant is not monitoring the periphery of the vehicle.

7. The vehicle control device according to claim 3, wherein:
the drive restriction unit switches between the timing drive restriction and the immediate drive restriction according to a state of an occupant of the vehicle;
the drive restriction unit executes the timing drive restriction for executing the drive restriction after waiting for the state of the occupant is in a state where the occupant is not executing a specific action when the state of the occupant is in a state where the occupant is executing the specific action during the autonomous driving without an obligation to monitor a periphery of the vehicle; and
the specific action is either a second task as an action other than driving operation or an action equivalent to the second task, and is allowable for a driver of the vehicle during the autonomous driving without the obligation to monitor the periphery.

8. The vehicle control device according to claim 3, wherein:
the drive restriction unit executes the immediate drive restriction when there is no following vehicle within a predetermined range behind the vehicle; and
the drive restriction unit executes the timing drive restriction for executing the drive restriction after the following vehicle is not disposed within the predetermined range behind the vehicle when there is the following vehicle within the predetermined range behind the vehicle.

9. The vehicle control device according to claim 1, wherein:
the drive restriction unit executes the drive restriction by repeatedly switching between a full mode in which the vehicle is travelling at a predetermined vehicle speed for the autonomous driving and a recovery mode in which the vehicle is travelling at a vehicle speed restricted to be lower than the predetermined vehicle speed for the autonomous driving when the continuation amount of the autonomous driving specified by the continuation specifying unit exceeds the predetermined threshold.

10. The vehicle control device according to claim 1, further comprising:
an vehicle compartment notification processing unit that issues a notification to an occupant of the vehicle, wherein:
the vehicle compartment notification processing unit issues the notification to the occupant of the vehicle suggesting a rest when a difference between the continuation amount of the autonomous driving specified by the continuation specifying unit and the predetermined threshold becomes less than a set value; and
the vehicle compartment notification processing unit issues the notification to the occupant of the vehicle to execute the drive restriction if the occupant of the vehicle does not take a rest.

11. The vehicle control device according to claim 1, further comprising:
an vehicle compartment notification processing unit that issues a notification to an occupant of the vehicle, wherein:
the vehicle compartment notification processing unit issues the notification to the occupant of the vehicle to prompt the occupant to check the vehicle when a difference between the continuation amount of the autonomous driving specified by the continuation specifying unit and the predetermined threshold becomes less than a set value.

12. The vehicle control device according to claim 1, further comprising:
an vehicle compartment notification processing unit that issues a notification to an occupant of the vehicle; and
a maintenance specifying unit that specifies whether the vehicle requires maintenance, wherein:
the vehicle compartment notification processing unit periodically issues a necessity notification to the occupant of the vehicle whether the vehicle requires the maintenance based on a specifying result of the maintenance specifying unit during the autonomous driving of the vehicle.

13. The vehicle control device according to claim 1, further comprising:
a drive plan unit that determines a drive plan for the autonomous driving of the vehicle, wherein:
the drive plan unit determines the drive plan in which the vehicle travels along a route that passes through a location where maintenance of the vehicle can be executed when determining the drive plan in which the continuation amount of the autonomous driving of the vehicle is scheduled to reach a specific amount.

14. The vehicle control device according to claim 1, wherein:
the vehicle is a remote control vehicle that is capable of executing the autonomous driving by a remote control operation,
the vehicle control device further comprising:
a center notification processing unit that issues a notification to a remote operator of a monitoring center who remotely controls the vehicle, wherein:
the center notification processing unit issues the notification to the remote operator suggesting a rest when a difference between the continuation amount of the autonomous driving specified by the continuation specifying unit and the predetermined threshold becomes less than a set value, and the vehicle is being autonomously driven by the remote control operation; and
the center notification processing unit issues the notification to the remote operator to execute the drive restriction if the remote operator does not take a rest.

15. The vehicle control device according to claim 1, wherein:
the vehicle is a remote control vehicle that is capable of executing the autonomous driving by a remote control operation,
the vehicle control device further comprising:
a center notification processing unit that issues a notification to a remote operator of a monitoring center who remotely controls the vehicle, wherein:
the center notification processing unit issues the notification to the remote operator suggesting an exchange in the remote control operation when a difference between the continuation amount of the autonomous driving specified by the continuation specifying unit and the predetermined threshold becomes less than a set value, and the vehicle is being autonomously driven by the remote control operation.

16. The vehicle control device according to claim 1, further comprising:
a driving environment specifying unit that specifies a driving environment of the vehicle; and
a threshold change unit that changes the predetermined threshold to be smaller as the driving environment specified by the driving environment specifying unit becomes a worse condition for driving the vehicle.

17. The vehicle control device according to claim 1, wherein:
the drive restriction unit executes the drive restriction by driving the vehicle to restrict a vehicle speed to be lower than a set vehicle speed for the autonomous driving when the continuation amount of the autonomous driving specified by the continuation specifying unit exceeds the predetermined threshold.

18. The vehicle control device according to claim 9, wherein:
the drive restriction unit changes a ratio between a normal period and a recovery period according to load related information that is information related to a load on the vehicle when repeating a full mode in which the vehicle is travelling at a predetermined vehicle speed for the autonomous driving and a recovery mode in which the vehicle is travelling at a vehicle speed restricted to be lower than the predetermined vehicle speed for the autonomous driving;
the normal period is a period during which the full mode continues; and
the recovery period is a period during which the recovery mode continues.

19. The vehicle control device according to claim 9, wherein:
the drive restriction unit changes a ratio between a normal period and a recovery period according to a state of an occupant of the vehicle when repeating a full mode in which the vehicle is travelling at a predetermined vehicle speed for the autonomous driving and a recovery mode in which the vehicle is travelling at a vehicle speed restricted to be lower than the predetermined vehicle speed for the autonomous driving;
the normal period is a period during which the full mode continues; and
the recovery period is a period during which the recovery mode continues.

20. The vehicle control device according to claim 19, wherein:
the drive restriction unit increases the ratio of the recovery period compared to the normal period when the state of the occupant of the vehicle is in an asleep state or in a poor physical condition.

21. The vehicle control device according to claim 19, wherein:
the drive restriction unit increases the ratio of the normal period compared with the recovery period when the state of the occupant of the vehicle is a state in which the occupant is monitoring a periphery of the vehicle.

22. The vehicle control device according to claim 19, wherein:
the drive restriction unit increases the ratio of the normal period compared with the recovery period when the state of the occupant of the vehicle is in a state where the occupant is executing a specific action during the autonomous driving without an obligation to monitor a periphery of the vehicle;
the specific action is either a second task as an action other than driving operation or an action equivalent to the second task, and is allowable for a driver of the vehicle during the autonomous driving without an obligation to monitor the periphery; and
the drive restriction unit increases the ratio of the recovery period compared with the normal period when the state of the occupant of the vehicle is in a state where the occupant is not executing the specific action or in a state where the occupant is in a rest posture.

23. The vehicle control device according to claim 9, wherein:
the drive restriction unit executes the drive restriction to start driving in a recovery mode when the vehicle starts driving again within a predetermined short period of time as a first specific period after driving a long distance that is greater than or equal to a specific distance; and
in the recovery mode, the vehicle is travelling at a vehicle speed restricted to be lower than a predetermined vehicle speed for the autonomous driving.

24. The vehicle control device according to claim 9, wherein:
the drive restriction unit increases a ratio of a normal period compared with a recovery period when a weight of a cargo bed of the vehicle is equal to or greater than a first threshold value when repeating a full mode in which the vehicle is travelling at a predetermined vehicle speed for the autonomous driving and a recovery mode in which the vehicle is travelling at a vehicle speed restricted to be lower than the predetermined vehicle speed for the autonomous driving;
the normal period is a period during which the full mode continues;
the recovery period is a period during which the recovery mode continues; and
the drive restriction unit increases the ratio of the recovery period compared with the normal period when the weight of the cargo bed of the vehicle is less than a second threshold value that is equal to or less than the first threshold value.

25. The vehicle control device according to claim 9, wherein:
the drive restriction unit increases a ratio of a recovery period compared with a normal period when the vehicle is travelling on a road with a downward slope when repeating a full mode in which the vehicle is travelling at a predetermined vehicle speed for the autonomous driving and a recovery mode in which the vehicle is travelling at a vehicle speed restricted to be lower than the predetermined vehicle speed for the autonomous driving;
the normal period is a period during which the full mode continues;
the recovery period is a period during which the recovery mode continues; and
the drive restriction unit increases the ratio of the normal period compared with the recovery period when the vehicle is travelling on the road with an upward slope.

26. The vehicle control device according to claim 9, wherein:
the drive restriction unit executes the drive restriction to start driving in a recovery mode or a manual driving mode when the vehicle starts driving again after continuously suspending to drive the vehicle for a long period of time that is equal to or longer than a second specific period; and
in the recovery mode, the vehicle is travelling at a vehicle speed restricted to be lower than the predetermined vehicle speed for the autonomous driving.

27. The vehicle control device according to claim 26, wherein:
the drive restriction unit switches to a full mode when determining that a battery of the vehicle is in a healthy state after the vehicle starts driving by executing the drive restriction to start driving in a recovery mode or a manual driving mode;
in the full mode, the vehicle is travelling at a predetermined vehicle speed for the autonomous driving; and
in the recovery mode, the vehicle is travelling at a vehicle speed restricted to be lower than the predetermined vehicle speed for the autonomous driving.

28. The vehicle control device according to claim 1, further comprising:
at least one of (i) a circuit and (ii) a processor having a memory storing computer program code, wherein:
the at least one of the circuit and the processor having the memory is configured to cause the vehicle control device to provide at least one of: the continuation specifying unit; and the drive restriction unit.

29. A vehicle control device usable for a vehicle that executes an autonomous driving, the vehicle control device comprising:
a continuation specifying unit that specifies a continuation amount of the autonomous driving, which is a continuous driving time or a continuous driving distance of the vehicle in the autonomous driving;
an anomaly specifying unit that specifies whether there is an anomaly of the autonomous driving of the vehicle; and
an vehicle compartment notification processing unit that issues a notification to an occupant of the vehicle, wherein:
the vehicle compartment notification processing unit issues the notification indicating that there is no anomaly in the vehicle even if the continuation amount of the autonomous driving is larger than a predetermined threshold when the continuation amount of the autonomous driving specified by the continuation specifying unit exceeds the predetermined threshold and the anomaly specifying unit specifies that there is no anomaly in the autonomous driving.

30. The vehicle control device according to claim 29, further comprising:
a maintenance specifying unit that specifies whether the vehicle requires maintenance, wherein:
the vehicle compartment notification processing unit periodically issues a necessity notification whether the vehicle requires the maintenance based on a specifying result of the maintenance specifying unit during the autonomous driving of the vehicle; and
intervals between necessity notifications after a first necessity notification are shorter than an interval between a start of the autonomous driving and the first necessity notification.

31. The vehicle control device according to claim 29, further comprising:
a maintenance information acquisition unit that acquires maintenance information related to past maintenance of the vehicle, wherein:
the vehicle compartment notification processing unit changes an interval of a necessity notification according to a degree of execution of the maintenance based on the maintenance information acquired by the maintenance information acquisition unit.

32. The vehicle control device according to claim 29, further comprising:
at least one of (i) a circuit and (ii) a processor having a memory storing computer program code, wherein:
the at least one of the circuit and the processor having the memory is configured to cause the vehicle control device to provide at least one of: the continuation specifying unit; the anomaly specifying unit; and the vehicle compartment notification processing unit.

33. A vehicle control method usable for a vehicle that executes an autonomous driving, the vehicle control method, executed by at least one processor, comprising:
a continuation specifying step for specifying a continuation amount of the autonomous driving, which is a continuous driving time or a continuous driving distance of the vehicle in the autonomous driving; and
a drive restriction step for executing a drive restriction, which is a restriction on a driving operation in the autonomous driving, when the continuation amount of the autonomous driving specified in the continuation specifying step exceeds a predetermined threshold.

34. A vehicle control method usable for a vehicle that executes an autonomous driving, the vehicle control method, executed by at least one processor, comprising:
a continuation specifying step for specifying a continuation amount of the autonomous driving, which is a continuous driving time or a continuous driving distance of the vehicle in the autonomous driving;
an anomaly specifying step for specifying whether there is an anomaly of the autonomous driving of the vehicle; and
a vehicle compartment notification processing step for issuing a notification to an occupant of the vehicle, wherein:
the vehicle compartment notification processing step further includes: issuing the notification indicating that there is no anomaly in the vehicle even if the continuation amount of the autonomous driving is larger than a predetermined threshold when the continuation amount of the autonomous driving specified in the continuation specifying step exceeds the predetermined threshold and there is no anomaly in the autonomous driving in the anomaly specifying step.
